(19) United States
(12) Patent Application Publication
(10) Pub. No.: US 2007/0029875 A1
(43) Pub. Date: Feb. 8, 2007

(54) Brake pressure controller for vehicle

(75) Inventors: Takashi Kurosaki, Nagano (JP); Tomoaki Sekiya, Nagano (JP); Susumu Takahashi, Saitama (JP); Takeshi Kojima, Saitama (JP); Shigehiro Honda, Saitama (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignees: NISSIN KOGYO CO., LTD., Ueda-shi (JP); HONDA MOTOR CO., LTD., Tokyo (JP)

(21) Appl. No.: 11/494,771

(22) Filed: Jul. 28, 2006

(30) Foreign Application Priority Data
Jul. 28, 2005 (JP) 2005-218222
May 29, 2006 (JP) 2006-147841

(51) Int. Cl. B60T 8/62

(52) U.S. Cl. 303/187; 303/DIG. 2; 303/DIG. 1

(57) ABSTRACT

A brake pressure controller for a vehicle is provided which can reliably restrain the difference between the left and right brake pressures from becoming excessively large. A controller 52 of a vehicle brake pressure controller includes an allowable differential pressure setting device 52A for setting an allowable differential pressure between the left and right wheels based on parameters indicating a motion state of a vehicle, a target control pressure setting device 52B for setting a value obtained by summing up the allowable differential pressure set by the allowable differential pressure setting device 52A and a lower-friction-side brake pressure as a target control pressure of a higher-friction-side brake pressure, and a higher-friction-side brake pressure control device 52E for adjusting the higher-friction-side brake pressure to the target control pressure.

### CROSS-REFERENCE TO RELATED APPLICATIONS

This application claims the foreign priority benefit under Title 35, United States Code, section 119 (a)-(d), of Japanese Patent Applications No. 2005-218222, filed on Jul. 28, 2005, and No. 2006-147841, filed on May 29, 2006 in the Japan Patent Office, the disclosure of which is herein incorporated by reference in its entirety.

### BACKGROUND OF THE INVENTION

1. Field of the Invention

The present invention relates to a brake pressure controller for a vehicle which can improve stability of a vehicle running and turning on a split road surface.

2. Description of the Related Art

Recently, a brake pressure controller for a vehicle has become sophisticated, and a device with an anti-lock braking control function which prevents excessive slipping of wheels on a low-μ road (low-friction road) has been made widely practicable. As an application of the technique of the anti-lock braking control, a technique for increasing vehicle stability when a vehicle enters a split road surface (when the left and right wheels straddle the line between two surface areas with mutually different friction coefficients), is also known.

As such a technique, there has been known a technique which prevents excessive difference in brake pressure(differential pressure) between the left and right wheels by keeping or reducing the brake pressure (wheel brake pressure) on a lower-μ road side and slowly increasing the brake pressure on a higher-μ road side when the left and right wheels have a small speed difference and a deceleration rate (negative acceleration rate) of the lower-μ road side is equal to or more than a predetermined value (see Japanese Unexamined Patent Application Publication No. H06-144189).

In the conventional technique, the pressure difference is prevented from becoming excessively large by slowly increasing the brake pressure on the higher-μ road side. However, since this control is performed based on wheel speed and deceleration rate, the brake pressure on the lower-μ road side, for example, is reduced during the gradual increase in pressure in some cases. As a result, there arises a problem in that the pressure difference may exceed an allowable range and the vehicle may become unstable.

Therefore, it would be desirable to provide a brake pressure controller for a vehicle which can reliably restrain an excessive increase in brake pressure difference between the left and right wheels.

### SUMMARY OF THE INVENTION

In one aspect of the present invention, there is provided a brake pressure controller for a vehicle comprising: an allowable differential pressure setting device for setting an allowable differential pressure between a left wheel and a right wheel on an identical axle based on parameters indicating a motion state of a vehicle; a target control pressure setting device for setting a value obtained by summing up the allowable differential pressure set by the allowable differential pressure setting device and a lower-friction-side brake pressure to be applied to a lower-friction-side wheel of the left and right wheels, as a target control pressure of a higher-friction-side brake pressure to be applied to a higher-friction-side wheel; and a higher-friction-side brake pressure control device for adjusting the higher-friction-side brake pressure to the target control pressure.

In another aspect of the present invention, there is provided a brake pressure controller for a vehicle comprising: an allowable differential pressure setting device for setting an allowable differential pressure between a left wheel and a right wheel on an identical axle based on parameters indicating a motion state of a vehicle; a target brake pressure setting device for setting individual target brake pressures of the left and right wheels; a right wheel target pressure limit setting device for setting a value obtained by summing up the allowable differential pressure and the target brake pressure of the left wheel as a target pressure limit of the right wheel; a left wheel target pressure limit setting device for setting a value obtained by summing up the allowable differential pressure and the target brake pressure of the right wheel as a target pressure limit of the left wheel; a target control pressure setting device for setting the lower one between the target brake pressure and the target pressure limit for the left wheel as a target control pressure of the left wheel and setting the lower one between the target brake pressure and the target pressure limit for the right wheel as a target control pressure of the right wheel; and a brake pressure control device for adjusting individual brake pressures of the left and right wheels to the respective target control pressures.

### BRIEF DESCRIPTION OF THE DRAWINGS

FIG. 1 is a configuration diagram showing a vehicle equipped with a brake pressure controller according to the embodiment.

FIG. 2 is a configuration diagram showing the details of a fluid pressure unit of the brake pressure controller for a vehicle.

FIG. 3 is a block diagram showing a configuration of the controller.

FIG. 4A shows a relationship between the vehicle body speed and the allowable differential pressure. FIG. 4B shows a relationship between the lateral acceleration rate and the allowable differential pressure. FIG. 4C shows a relationship between the lower friction-side brake pressure and the allowable differential pressure.

FIG. 5 is a flowchart showing functions of the controller.

FIG. 6 is a flowchart showing functions of a higher-friction-side brake pressure control device.

FIG. 7 shows graphs. (a) shows an example of a time change in allowable differential pressure to be updated as required. (b) shows an example of time changes in lower-friction-side brake pressure and target control pressure.

FIG. 8 is a graph showing a method for controlling the higher-friction-side brake pressure.

FIG. 9 shows graphs. (a) shows an example of a time change in wheel speed. (b) shows an example of time changes in target deceleration rate and actual deceleration rate. (c) shows an example of a time change in deceleration difference.

FIG. 10 shows graphs. (a) shows an example of a time change in deceleration difference. (b) shows an example of a time change in pressure increment calculated based on the deceleration difference. (c) shows an example of a time change in target control pressure to which the pressure increment is added.

FIG. 11 is a block diagram showing a configuration of a controller according to another embodiment.

FIGS. 12 are drawings showing the relationships among the target brake pressure, the target pressure limit, and the allowable differential pressure. FIG. 12A is an explanatory view showing a case where the allowable differential pressure is lower than the difference between the target brake pressures of the left and right wheels. FIG. 12B is an explanatory view showing a case where the difference between the target brake pressures of the left and right wheels is equal to the allowable differential pressure. FIG. 12C is an explanatory view showing a case where the allowable differential pressure is higher than the difference between the target brake pressures of the left and right wheels.

FIG. 13 is a flowchart showing operations of the controller of FIG. 11.

FIG. 14 is a block diagram showing a configuration of the controller according to another embodiment.

FIG. 15 is a flowchart showing operations of the controller of FIG. 14.

FIG. 16 shows graphs. (a) shows an example of time changes in reference speed and velocity change. (b) shows an example of a time change in allowable differential pressure to be updated as required. (c) shows an example of time changes in lower-friction-side brake pressure and target control pressure.

FIG. 17 is a graph showing a method for controlling the higher-friction-side brake pressure according to another embodiment.

### DETAILED DESCRIPTION OF THE PREFERRED EMBODIMENTS

Next, an embodiment of the invention will be described in detail with reference to the drawings as appropriate.

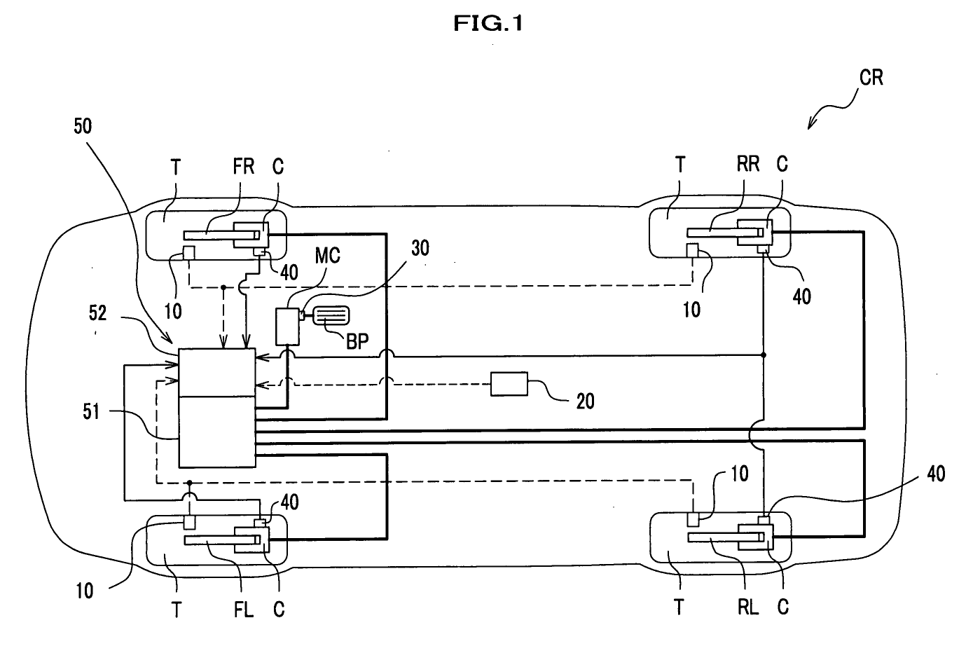

As shown in FIG. 1, in a vehicle CR, wheel speed sensors 10, a lateral acceleration sensor 20, a pedal sensor 30, and brake pressure sensors 40 are provided, and a brake controller 5 for a vehicle which controls brake pressures (in detail, brake fluid pressures) based on signals detected by these sensors 10 through 40 is provided.

The wheel speed sensors 10 are sensors for detecting wheel speeds of the respective wheels T, and are provided by one for each wheel T. The wheel speed sensors 10 are connected to the brake pressure controller 50, whereby the brake pressure controller 50 can acquire wheel speeds of all four wheels T. Each of the four wheel speed sensors 10 has a unique ID, with which the brake pressure controller 50 can identify to which wheel T a signal transmitted from a certain wheel speed sensor 10 belongs.

The lateral acceleration sensor 20 is a sensor for detecting an acceleration rate in the left and right direction of the vehicle CR (hereinafter, referred to as “lateral acceleration rate”). This lateral acceleration sensor 20 is connected to the brake pressure controller 50, whereby the brake controller 50 can acquire a lateral acceleration applied to the vehicle CR.

The pedal sensor 30 is a sensor for detecting a brake pressure corresponding to a brake depressing force inputted to a master cylinder MC from a brake pedal (brake operating element) BP as a brake pedal BP depressing amount (operating amount). This pedal sensor 30 is connected to the brake pressure controller 50, whereby the brake pressure controller 50 can acquire the brake pedal BP depressing amount. For the “brake operating element”, a brake pedal to be depressed by a foot was mentioned. However, it may be a brake lever to be operated by hand of a person who does not have full use of his/her legs.

The brake pressure sensor 40 is a sensor for detecting a brake pressure in each caliper C provided on each wheel T, and is provided by one for each caliper C. The brake pressure sensors 40 are connected to the brake pressure controller 50, whereby the brake pressure controller 50 can acquire all brake pressures applied to the four wheels T. The four brake pressure sensors 40 have respective unique IDs, with which the brake pressure controller 50 can identify to which wheel T a signal transmitted from a certain brake pressure sensor 40 belongs.

The brake pressure controller 50 is for properly controlling brake forces (brake pressures) applied to the respective wheels T of the vehicle CR, and mainly includes a fluid pressure unit 51 provided with a fluid passage and various parts, and a controller 52 for properly controlling the various parts in the fluid pressure unit 51. A brake pressure outputted from the fluid pressure unit 51 is supplied to the calipers C provided on the respective wheels T through piping, and by supplying the brake pressure to the respective calipers C, brake forces of the wheel brakes FL, RL, FR, and RR act on the respective wheels T.

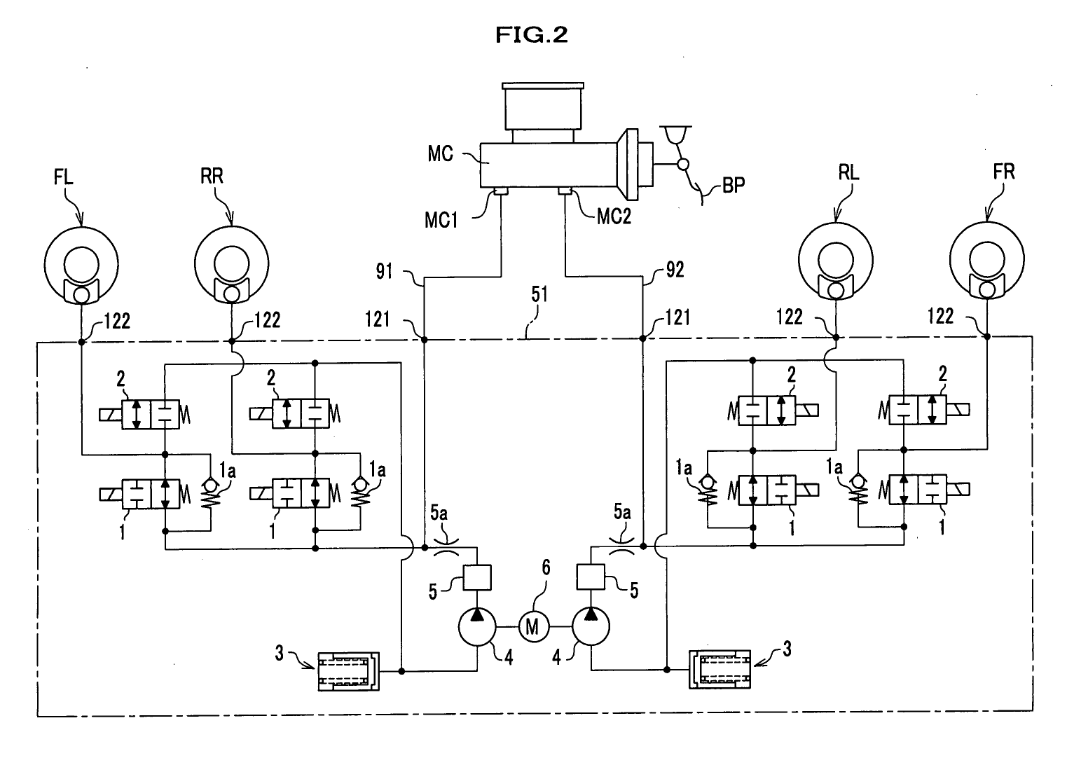

Hereinafter, a configuration of the fluid pressure unit 51 of the brake pressure controller 50 will be described with reference to FIG. 2. Among the drawings referred to, FIG. 2 is a configuration diagram showing details of the fluid pressure unit of the brake pressure controller for a vehicle.

The fluid pressure unit 51 is disposed between a master cylinder MC that generates a brake pressure corresponding to a depressing force that a driver applies to the brake pedal BP and the wheel brakes FL, RR, RL, and FR. Two output ports MC1 and MC2 of the master cylinder MC are connected to inlet ports 121 of the fluid pressure unit 51, and outlet ports 122 of the fluid pressure unit 51 are connected to the respective wheel brakes FL, RR, RL, and FR. Then, normally, the passage from the inlet ports 121 of the fluid pressure unit 51 to the outlet ports 122 serve as communicating fluid passages, whereby a depressing force on the brake pedal BP is transmitted to the respective wheel brakes FL, RR, RL, and FR.

The fluid pressure unit 51 is provided with four inlet valves 1, four outlet valves 2, and four check valves la corresponding to the respective wheel brakes FL, RR, RL, and FR. For each of output fluid pressure passages 91 and 92 corresponding to the output ports MC1 and MC2, a reservoir 3, a pump 4, a damper 5 and an orifice 5a are provided. An electrical motor 6 is provided for driving the two pumps 4.

The inlet valve 1 is a solenoid valve which is disposed between the respective wheel brakes FL, RR, RL, and FR and the master cylinder MC and normally left open. Under normal conditions, the inlet valve 1 is left open and allows a brake pressure to be transmitted from the master cylinder MC to each of the wheel brakes FL, RR, RL, and FR. When the wheel is about to be locked, the inlet valve 1 is closed according to execution of anti-lock braking control by the controller 52 (see FIG. 1), which blocks transmission of the fluid pressure caused by the brake pedal BP to each of the wheel brakes FL, RR, RL, and FR. Under the anti-lock braking control, the inlet valves 1 are properly opened by the controller 52, whereby a brake pressure based on a braking depressing force is transmitted again to the respective wheel brakes FL, RR, RL, and FR and brake pressures thereof are increased.

The outlet valve 2 is a solenoid valve which is disposed between the respective wheel brakes FL, RR, RF, and FR and the respective reservoirs 3 and normally left closed. Under normal conditions, the outlet valve 2 is left closed. When the wheel is about to be locked, the outlet valve is opened by the controller 52 and the brake fluid pressures acting on a caliper C of each of the wheel brakes FL, RR, RL, and FR are released to the reservoirs 3, whereby brake pressures of the wheel brakes are reduced. By closing these outlet valves 2 and inlet valves 1 during the anti-lock braking control, the respective brake pressures are maintained.

The check valve la is connected in parallel with the corresponding inlet valve 1. The check valve la allows a flow of the brake fluid only from wheel brake FL, RR, RL, and FR-sides to the master cylinder MC-side, and even when the brake pedal BP is freed while the inlet valve 1 is left closed, the brake fluid is allowed to flow from the respective wheel brake FL, RR, RL, and FR-sides to the master cylinder MC-side.

The reservoirs 3 have a function to absorb a brake pressure released from each opened outlet valves 2.

The pumps 4 have a function to suck in the brake fluid absorbed by the reservoirs 3 and return the brake fluid to the master cylinder MC through the dampers 5 and the orifices 5a. Thereby, pressure states of the output fluid pressure passages 91 and 92 decompressed due to absorption of the brake pressure in the reservoirs 3 are restored.

As shown in FIG. 1, the controller 52 has, for example, a CPU, a RAM, a ROM, and an I/O circuit, and performs anti-lock braking control and differential pressure control of brake pressures to be applied to the calipers C of a left wheel T and a right wheel T (hereinafter, also referred to as “left and right wheels T,T”) during this anti-lock braking control by performing various arithmetic processings based on the above-described signals of the sensors 10 through 40 and programs and data stored in the ROM.

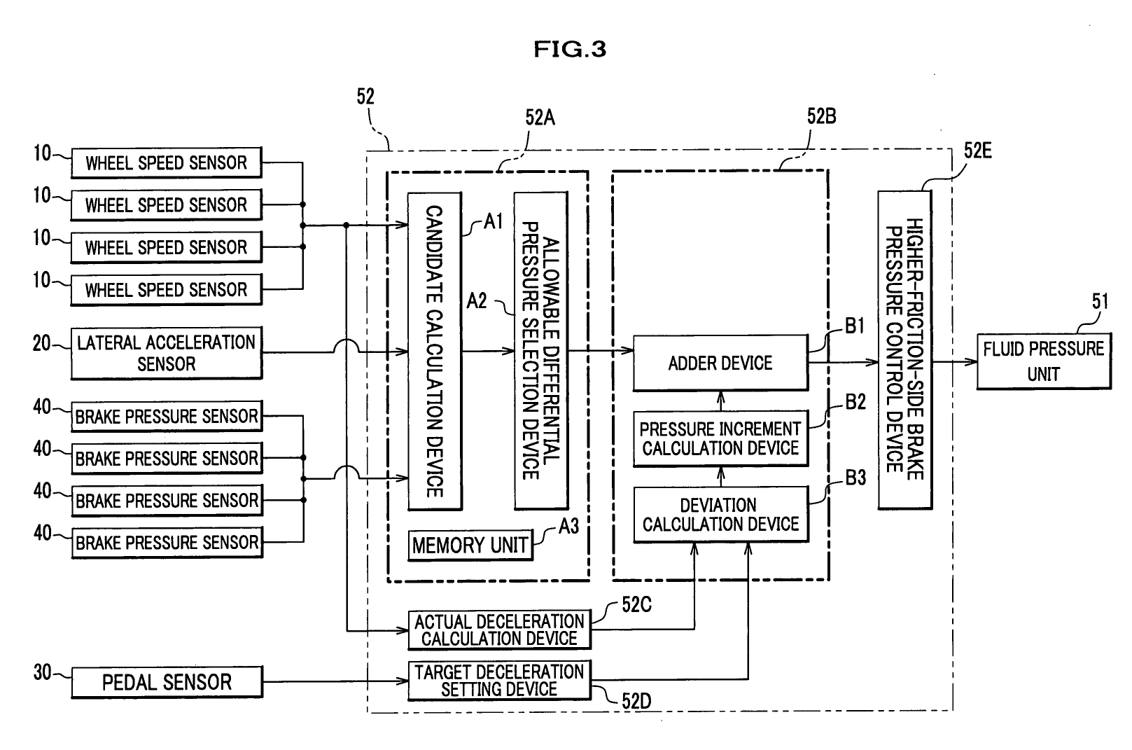

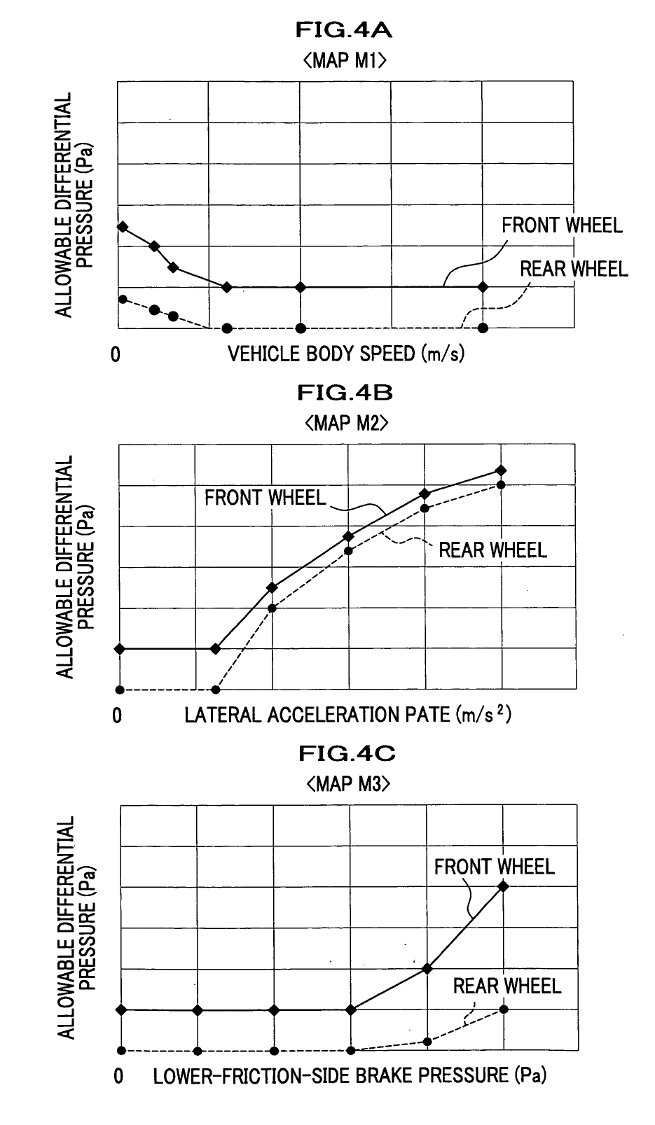

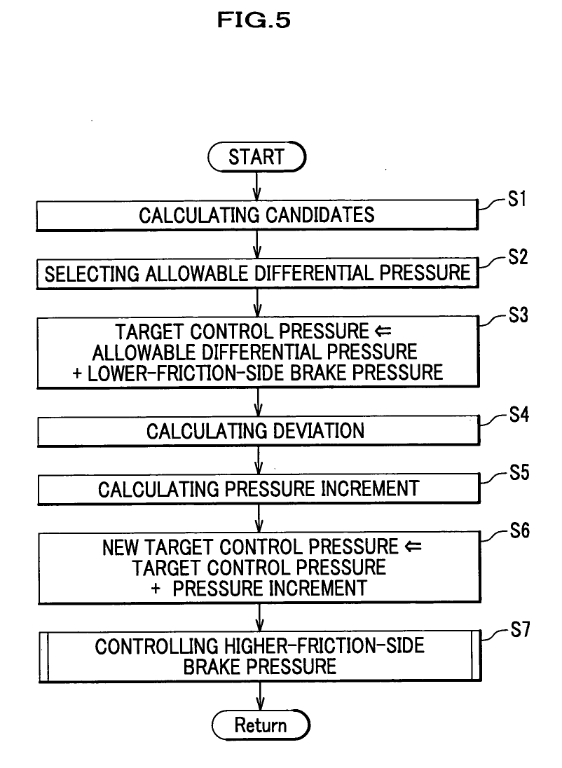

Hereinafter, among the functions of the controller 52, a function to perform the above-described differential pressure control will be described in detail with reference to FIG. 3 through FIG. 5. Among the drawings to be referred to, FIG. 3 is a block diagram showing a configuration of the controller, FIG. 4A shows a relationship between the vehicle body speed and an allowable differential pressure, FIG. 4B shows a relationship between the lateral acceleration rate and an allowable differential pressure, and FIG. 4C shows a relationship between a lower-friction-side brake pressure and an allowable differential pressure. FIG. 5 is a flowchart showing the functions of the controller.

The term “allowable differential pressure” herein means an index pressure indicating to what degree the difference between the brake pressure to be applied to the left wheel and the brake pressure to be applied to the right wheel can be increased according to the road surface state (vehicle motion state) and the like. Also, the term “parameters indicating the motion state of a vehicle” means parameters such as a vehicle body speed, a lateral acceleration rate, and a brake pressure.

As shown in FIG. 3, the controller 52 includes an allowable differential pressure setting device 52A, a target control pressure setting device 52B, an actual deceleration calculation device 52C, a target deceleration setting device 52D, and a higher-friction-side brake pressure control device 52E. The controller 52 may also have functions of conventional anti-lock braking control, etc. The term “deceleration” herein means an acceleration to be applied in the opposite direction of the running direction when the wheel decelerates (negative acceleration).

The allowable differential pressure setting device 52A has a candidate calculation device A1, an allowable differential pressure selection device A2, and a memory unit A3, and by these devices, an allowable differential pressure between the left and right wheels T,T on the front side and an allowable differential pressure between the left and right wheels T,T on the rear side are set. A method for setting the allowable differential pressures and subsequent control methods are the same between the front left and right wheels T,T and the rear left and right wheels T,T. Therefore, description will be given representatively for the front left and right wheels T,T, hereinafter.

The candidate calculation device A1 mainly has a function to acquire maps M1, M2, and M3 shown in FIG. 4A through FIG. 4C from the memory unit A3, and a function (FIG. 5, Step S1) to calculate first, second, and third allowable differential pressure candidates from the acquired maps M1, M2, and M3 and signals from the respective sensors 10, 20, and 40. Specifically, the candidate calculation device A1 has a function to calculate a vehicle body speed based on wheel speeds detected by the respective wheel speed sensors 10, and calculate a first candidate of an allowable differential pressure based on this vehicle body speed and the map M1. The candidate calculation device A1 also has a function to calculate a second candidate of an allowable differential pressure based on the lateral acceleration rate detected by the lateral acceleration sensor 20 and the map M2. Furthermore, the candidate calculation device A1 has a function to select a lower-s road side brake pressure (hereinafter, referred to as “lower-friction-side brake pressure”, which means “brake pressure on a lower-friction side”) from two brake pressures corresponding to the front left and right wheels (coaxial wheels) T,T among the brake pressures detected by the respective brake pressure sensors 40, and calculate a third candidate of an allowable differential pressure based on the selected lower-friction-side brake pressure and the map M3.

Then, the candidate calculation device A1 outputs the allowable differential pressure candidates calculated as described above to the allowable differential pressure selection device A2. The brake pressure on the lower-friction side selected by the candidate calculation device A1 is outputted to the target control pressure setting device 52B (specifically, an adder device B1 which will be described later) via the allowable differential pressure selection device A2, and the brake pressure (higher-friction-side brake pressure) on the opposite side of the lower-friction-side brake pressure is outputted to the higher-friction-side brake pressure control device 52E via the allowable differential pressure selection device A2 and the adder device B1.

The vehicle body speed can be calculated based on acceleration rates of the vehicle body detected by front and rear acceleration sensors instead of calculating from the wheel speeds. Any method can be used as the method for selecting the lower-friction-side brake pressure.

The allowable differential pressure selection device A2 has a function (FIG. 5, Step S2) to select and set a candidate with the highest allowable differential pressure among the differential pressure candidates transmitted from the candidate calculation device A1 as an allowable differential pressure. Then, the allowable differential pressure selection device A2 outputs the selected allowable differential pressure to the target control pressure setting device 52B.

The memory unit A3 stores the maps M1, M2, and M3. The map M1 is set so that the allowable differential pressure becomes highest when the vehicle body speed is zero, and then as the vehicle body speed increases, the allowable differential pressure gradually lowers therefrom, and converges to zero (approaches zero on the front wheel side) when the vehicle body speed becomes equal to or higher than a predetermined value. The reason for this setting is that when the vehicle body speed is near zero, the vehicle CR stops soon and no problem arises even with a high allowable differential pressure.

The map M2 is set so that when the lateral acceleration rate becomes equal to or more than a predetermined value, the allowable differential pressure gradually increases therefrom. The reason for this setting is that, since the vehicle weight is greatly put on the outer wheels during turning of the vehicle CR, excellent brake force can be obtained by increasing the brake pressures of the external wheels.

The map M3 is set so that when the lower-friction-side brake pressure becomes equal to or more than a predetermined value, the allowable differential pressure increases therefrom. The reason for this setting is that when the lower-friction-side brake pressure is high, it is supposed that the road surface is not a split road surface with different road surface coefficients between the left wheel and the right wheel on the identical axle, thus no problem arises as a result of increasing the allowable differential pressure, and even an excellent brake force can be obtained. These maps M1, M2 and M3 are prepared in advance for the respective front wheel side and rear wheel side based on results of experiments and simulations.

In each of the maps M1, M2 and M3, the front wheel allowable differential pressure is entirely higher than the rear wheel allowable differential pressure.

The target control pressure setting device 52B includes an adder device B1, a pressure increment calculation device B2 and a deviation calculation device B3, and with these devices, a target control pressure as a target value of the higher-μ road side brake pressure (hereinafter, referred to as “higher-friction-side brake pressure”) is set. For the sake of convenience, description about the pressure increment calculation device B2 and the deviation calculation device B3 will be given after descriptions about the actual deceleration calculation device 52C and the target deceleration setting device 52D given later.

The adder device B1 has a function to sum up two signals (allowable differential pressure and lower-friction-side brake pressure) outputted from the allowable differential pressure selection device A2 when no signal is outputted from the pressure increment calculation device B2 which will be described later, and set the value as a target control pressure (FIG. 5, Step S3). The adder device B1 also has a function to increase the target control pressure when a signal is outputted from the pressure increment calculation device B2 by summing up the value (pressure increment) of this signal and the target control pressure and set a resultant value as a new target control pressure (FIG. 5, Step S6). Then, this adder device B1 outputs the target control pressure or the new target control pressure set as described above to the higher-friction-side brake pressure control device 52E.

The actual deceleration calculation device 52C has a function to select a higher-friction-side wheel speed from wheel speeds detected by the wheel speed sensors 10, 10 of the left and right wheels T,T, and calculate an actual deceleration rate (deceleration rate in actuality) on the higher-friction side based on this wheel speed. The actual deceleration calculation device 52C outputs the calculated actual deceleration rate to the deviation calculation device B3 of the target control pressure setting device 52B.

The target deceleration setting device 52D has a function to set a target deceleration rate (deceleration rate that should be reached at least by expecting a safety ratio from a depressing amount on the brake pedal BP) of the higher-friction-side wheel T based on the brake pressure detected by the pedal sensor 30 (information on the depressing amount on the brake pedal BP). Then, this target deceleration setting device 52D outputs the set target deceleration rate to the deviation calculation device B3 of the target control pressure setting device 52B.

The deviation calculation device B3 has a function (FIG. 5, Step S4) to calculate a deviation between an actual deceleration rate transmitted from the actual deceleration calculation device 52C and a target deceleration rate transmitted from the target deceleration setting device 52D. The term “deviation” herein means a value obtained by subtracting an absolute value of the actual deceleration rate from an absolute value of the target deceleration rate. Then, this deviation calculation device B3 outputs the calculated deviation to the pressure increment calculation device B2.

The pressure increment calculation device B2 has a function (FIG. 5, Step S5) to calculate an increase in target control pressure based on the deviation calculated by the deviation calculation device B3, specifically, a function to calculate a pressure increment by multiplying the deviation by a predetermined coefficient. This pressure increment calculation device B2 outputs the pressure increment to the adder device B1 only when the calculated pressure increment is equal to or more than zero. One example in which the deviation calculation device B3 and the pressure increment calculation device B2 are actuated is a case in which, when a driver depresses the brake pedal BP, even if a brake force that should be obtained from this depressing amount cannot be obtained and the target deceleration rate and the actual deceleration rate are greatly different, an excellent brake force can be obtained by adding a pressure increment calculated based on the deviation between these to the target control pressure.

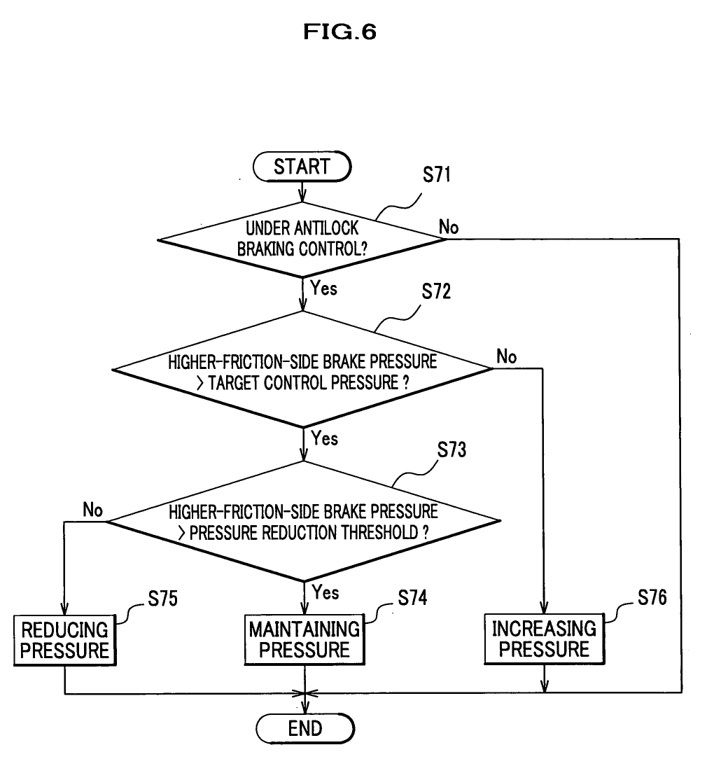

The higher-friction-side brake pressure control device 52E has a function (FIG. 5, Step S7) to control the inlet valves 1, the outlet valves 2, and the pumps 4 (see FIG. 2) of the fluid pressure unit 51 properly so that the higher-friction-side brake pressure is adjusted to the target control pressure based on the target control pressure outputted from the adder device B1 (or new target control pressure; hereinafter, the term “target control pressure” also includes the new target control pressure) and a higher-friction-side brake pressure outputted from the candidate calculation device A1 through the allowable differential pressure selection device A2 and the adder device B1. This higher-friction-side brake pressure control device 52E is actuated with the start of anti-lock braking control, that is, performs control so that the higher-friction-side brake pressure is adjusted to the target control pressure for the first time when receiving a control start signal from an unillustrated anti-lock braking control device. Specifically, this higher-friction-side brake pressure control device 52E performs control according to the process of FIG. 6.

Hereinafter, the functions of the higher-friction-side brake pressure control device 52E will be described in detail. Among the drawings to be referred to, FIG. 6 is a flowchart showing the functions of the higher-friction-side brake pressure control device.

The higher-friction-side brake pressure control device 52E judges first whether the vehicle is under anti-lock braking control (Step S71), and when it is judged that the vehicle is not under anti-lock braking control (No), the control is directly terminated (END). At Step S71, when it is judged that the vehicle is under anti-lock braking control (Yes), it is judged whether the higher-friction-side brake pressure has exceeded the target control pressure (Step S72). Then, when it is judged that the higher-friction-side brake pressure has exceeded the target control pressure at Step S72 (Yes), it is judged whether the higher-friction-side brake pressure has exceeded a pressure reduction threshold (which is calculated by adding a predetermined value to the target control pressure) (Step S73). Then, when the higher-friction-side brake pressure exceeds the pressure reduction threshold (Yes), the higher-friction-side brake pressure is reduced (Step S74), and when it does not exceed (No), the higher-friction-side brake pressure is maintained (Step S75), and this control is ended (END).

At Step S72, when it is judged that the higher-friction-side brake pressure has not exceeded the target control pressure (No), the higher-friction-side brake pressure is increased (Step S76), and then the control is ended (END). In this pressure increasing control, as the deviation between the target control pressure and the current higher-friction-side brake pressure becomes larger, the pressure increment rate is increased so that the current pressure more quickly approaches the target control pressure.

After the flow of FIG. 6, the process returns to the flow of FIG. 5, and Steps S1 through S7 described above are repeated (Return). Then, this flow of FIG. 5 is terminated concurrently with the end of the anti-lock braking control.

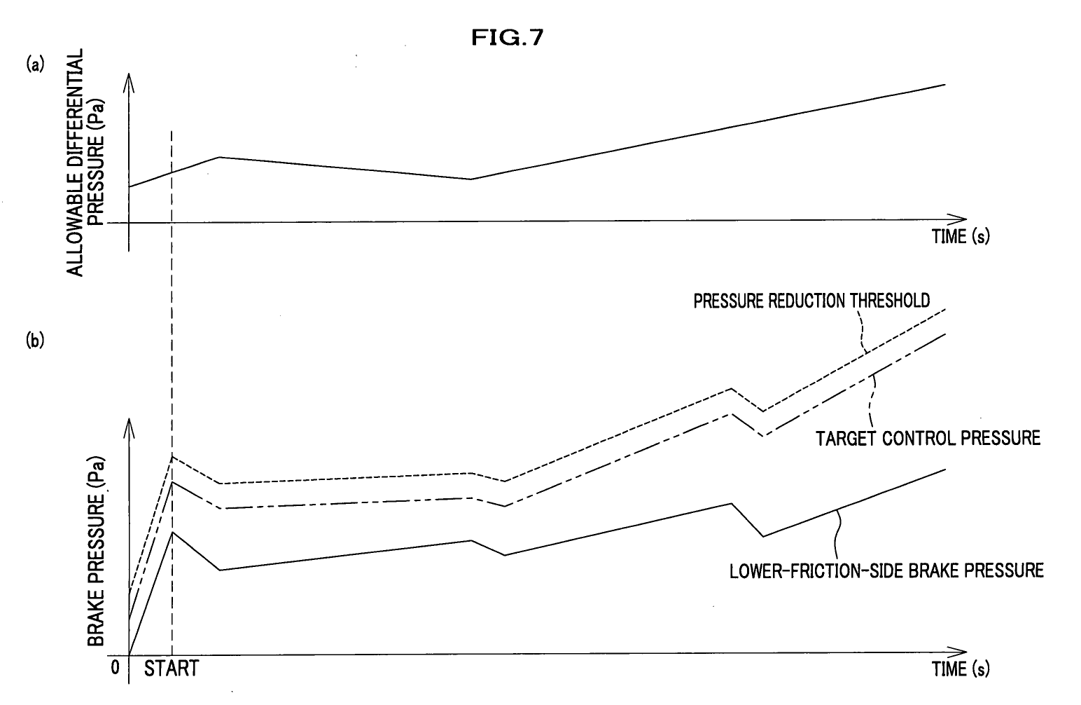

Next, an example is described in which the above-described differential pressure control is performed for a predetermined period of time. Referring to FIG. 7, (a) shows an example of a time change in allowable differential pressure updated as required, and (b) shows an example of time changes in lower-friction-side brake pressure and target control pressure.

As shown in (a) of FIG. 7, the allowable differential pressure setting (calculation and selection of the candidates) is always performed after depression of the brake pedal BP till cancellation of the depression, and by updating the set value as required based on the parameters and maps, the allowable differential pressure (set value) changes with time as shown in the graph. In this case where the allowable differential pressure changes with time, if the lower-friction-side brake pressure changes with time, the target control pressure of the higher-friction-side brake pressure obtained by adding the allowable differential pressure to this lower-friction-side brake pressure also changes with time, as shown by the alternate long and short double dashed line in (b) of FIG. 7. Furthermore, the pressure reduction threshold obtained by adding a predetermined value to this target control pressure changes with time along with the target control pressure (as if offsetting the target control pressure) as shown by the dashed line in the graph.

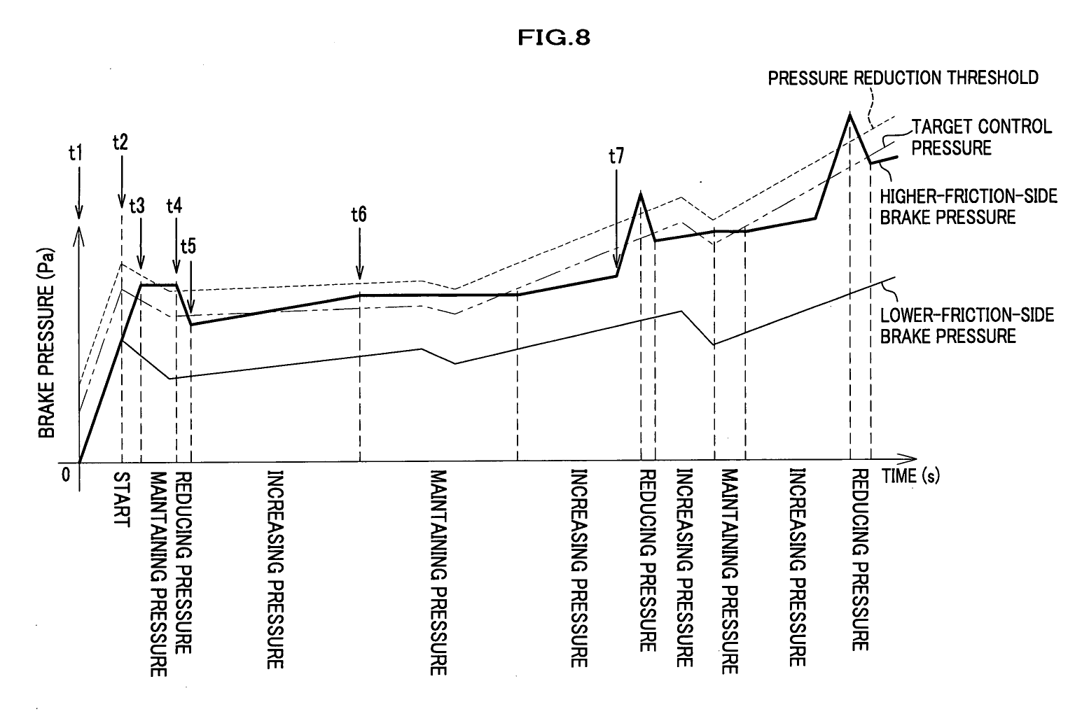

Next, a method for controlling the higher-friction-side brake pressure will be described with reference to FIG. 8. Among the drawings to be referred to, FIG. 8 is a graph showing a method for controlling the higher-friction-side brake pressure.

As shown in FIG. 8, when a driver depresses the brake pedal BP (at time t1), calculation of the target control pressure is started and the left and right brake pressures increase together (in a time period of t1-t2). Then, when the vehicle CR enters a split road surface and a wheel T on one side slips, anti-lock braking control is started, and the brake pressure (lower-friction-side brake pressure) to be applied to the slipping wheel T is reduced (at time t2). This control follows a basic flow in FIG. 5, from START through Steps S1-S7, to RETURN in this order, and various controls according to the conditions are performed at Step S7. The control at Step S7 (hereinafter, simply referred to as “brake pressure control”) proceeds from START through Step S71 (No) to END in this order as shown in FIG. 6, in a time period of t1-t2. The brake pressure control in a time period of t2-t3 proceeds from START, through Step S71 (Yes), Step S72 (No) and Step S76, to END in this order. At Step S76 (pressure increment control) in the time period of t2-t3, control is performed by, for example, leaving the inlet valves 1 (see FIG. 2) open that have already been opened before starting the anti-lock braking control, which consequently increases pressure.

Returning to FIG. 8, when the higher-friction-side brake pressure becomes higher than the target control pressure (at time t3), control for maintaining the higher-friction-side brake pressure is performed, and when the higher-friction-side brake pressure becomes higher than a pressure reduction threshold (time t4), control for reducing the higher-friction-side brake pressure is performed. Furthermore, when the higher-friction-side brake pressure becomes lower than the target control pressure (time t5), control for increasing the higher-friction-side brake pressure is performed.

The pressure maintaining control in a time period of t3-t4 proceeds from START through Step S71 (Yes), Step S72 (Yes), Step S73 (No) and Step S75 to END in this order as shown in FIG. 6. The pressure reducing control in a time period of t4-t5 proceeds from START through Step S71 (Yes), Step S72 (Yes), Step S73 (Yes) and Step S74, to END in this order. Furthermore, the pressure increasing control in a time period of t5-t6 proceeds from START through Step S71 (Yes), Step S72 (No) and Step S76 to END in this order.

In the pressure increasing control, as the deviation between the target control pressure and the higher-friction-side brake pressure becomes larger, the pressure increment rate is more increased as described above. Therefore, for example, when the deviation becomes large, the pressure increment rate is increased so that the target control pressure is reached quickly, as shown at time t7. In this embodiment, only two types of pressure increment rates, including rapid and slow rates, are disclosed. However in practice, it is preferable that the pressure increment rate is changed in small steps, and more preferably, the pressure increment rate is changed linearly (continuously).

It should be noted that the target control pressure shown in FIG. 8 follows the calculation shown in (a) and (b) of FIG. 7, that is, a target control pressure is obtained under the condition that the deviation between the actual deceleration rate of the wheel T on the higher-μ road side and a target deceleration rate is less than zero. When the deviation between the actual deceleration rate and the target deceleration rate is equal to or more than zero, a new increase pressure is added to the target control pressure and changes with time in a different manner from (a) of FIG. 7.

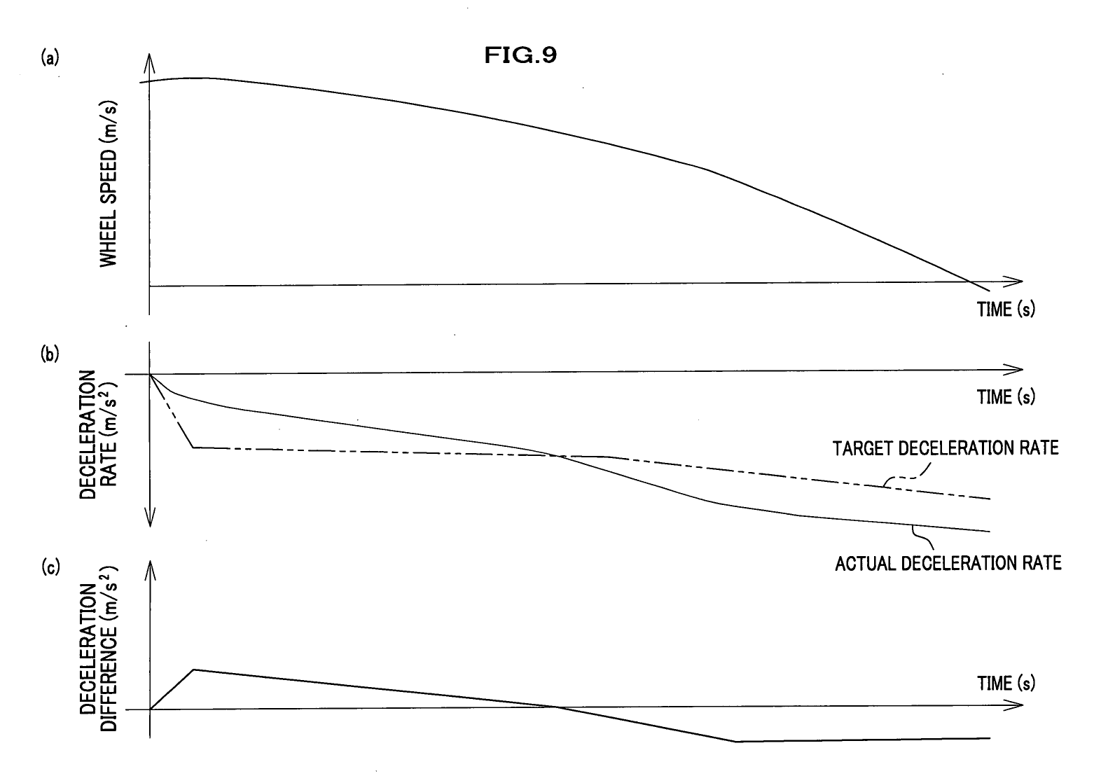

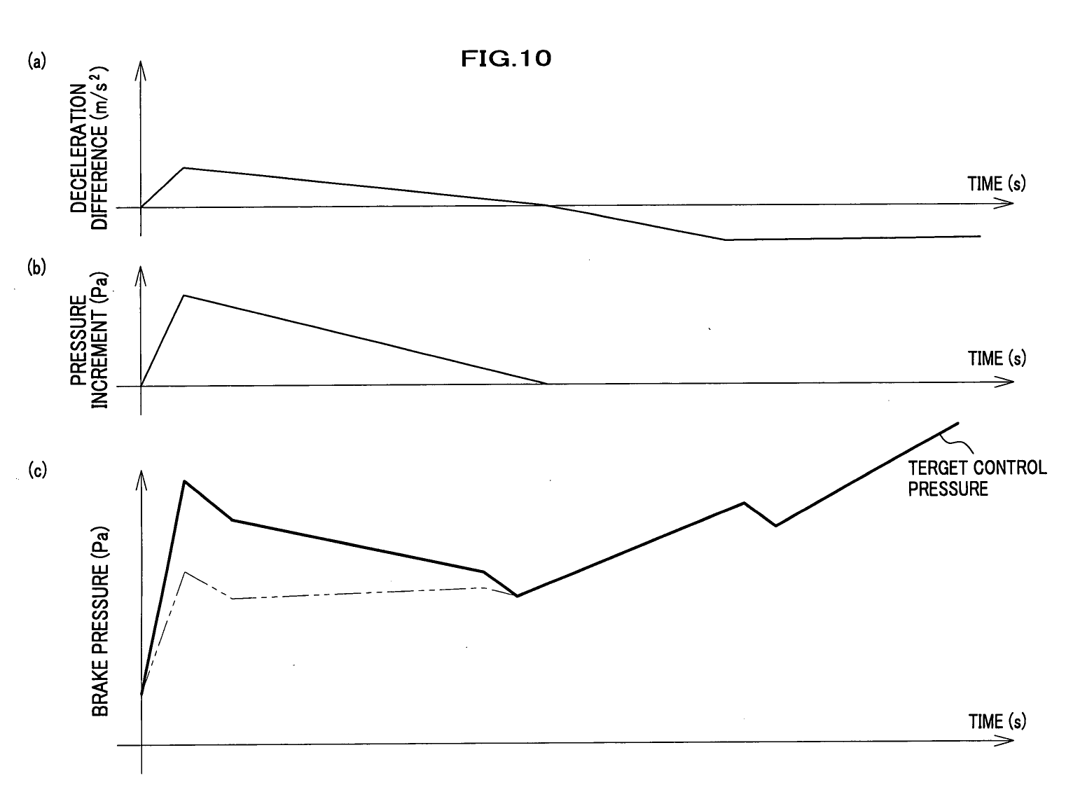

Hereinafter, the time change in target control pressure when the deviation between the actual deceleration rate and the target deceleration rate is equal to or more than zero will be described. Referring to FIG. 9, (a) shows an example of a time change in wheel speed, (b) showing an example of time changes in target deceleration rate and actual deceleration rate, and (c) showing an example of a time change in deceleration difference. FIG. 10 includes graphs. (a) shows an example of a time change in deceleration difference, (b) shows an example of a time change in pressure increment calculated based on the deceleration difference, and (c) shows an example of a time change in target control pressure to which the pressure increment is added.

Suppose the wheel speed changes with time according to depression of the brake pedal BP as shown in (a) of FIG. 9, the actual deceleration rate changes with time as shown by the solid line in (b) of FIG. 9, and the target deceleration rate changes with time as shown by the alternate long and short double dashed line in (b) of FIG. 9. In this case, a deviation (deceleration difference) between the actual deceleration rate and the target deceleration rate is calculated as required by the deviation calculation device B3, and the deviation changes with time as shown in (c) of FIG. 9. The vertical axis [deceleration rate] shown in (b) of FIG. 9 is positive downward, and the vertical axis [deceleration difference] shown in (c) of FIG. 9 is positive upward. Namely, in the first half of the time change of (b) of FIG. 9, the actual deceleration rate does not reach the target deceleration rate and a brake force corresponding to the deviation is required for attaining the target deceleration rate (short of the target deceleration rate), and in the latter half, the actual deceleration rate is more than the target deceleration rate, so that the brake force is sufficient. Therefore, in (c) of FIG. 9, when the deviation (deceleration difference) is positive, the brake force is short, and when it is negative, the brake force is sufficient.

When the deviation changes with time as described above, the deviation calculation device B3 outputs the deviation to the pressure increment calculation device B2 only when the deviation is equal to or more than zero, so that the pressure increment calculated by the pressure increment calculation device B2 changes with time in a range corresponding to positive deviations, and becomes zero in a range corresponding to negative deviations, as shown in (a) and (b) in FIG. 10. Therefore, when this pressure increment is added to the target control pressure by the adder device B1, as shown in (c) in FIG. 10, the first half of the target control pressure changes with time while being increased by the pressure increment.

The above-described configuration brings about the following effect in this embodiment.

An allowable differential pressure between the left and right wheels according to the state of the vehicle CR (parameters indicating the motion state of a vehicle CR) is calculated by the allowable differential pressure setting device 52A, and the allowable differential pressure is added to the lower-friction-side brake pressure by the target control pressure setting device 52B to set a target control pressure of the higher-friction-side brake pressure, and the higher-friction-side brake pressure control device 52E adjusts the higher-friction-side brake pressure to the target control pressure, from the viewpoint of focusing on the difference (allowable differential pressure) between the higher-friction-side brake pressure and the lower-friction-side brake pressure. As a result, the difference between the higher-friction-side brake pressure and the lower-friction-side brake pressure is maintained near the allowable differential pressure corresponding to the motion state of the vehicle, so that it can be reliably restrained that the difference between the left and right brake pressures becomes excessively large.

The higher-friction-side brake pressure is controlled based on a maximum value among allowable differential pressures corresponding to a vehicle speed, a lateral acceleration rate, and a lower-friction-side brake pressure indicating a motion state of the vehicle, so that a maximum brake force suitable for the motion state of the vehicle at the time can be obtained.

Since allowable differential pressures are derived from the maps M1, M2, and M3, accurate brake pressure control suitable for each vehicle type can be realized by preparing the maps M1, M2, and M3 from experiments and simulations, etc., adapted to various vehicle types.

When the actual deceleration rate is lower than the target deceleration rate by a predetermined amount or more, the target control pressure is increased. Accordingly, when the actual deceleration rate is lower than the target deceleration rate by a predetermined amount or more, the target control pressure is increased, and accordingly, the higher-friction-side brake pressure is increased, so that a more optimum brake force can be obtained. The term “actual deceleration rate is lower than the target deceleration rate by a predetermined amount or more” means that the level (absolute value) of the actual deceleration rate is smaller than the level of the target deceleration rate. Namely, when the deceleration rate is treated as a negative value, the wording means that the actual deceleration rate is at a value higher than the target deceleration rate.

When the actual deceleration rate is lower than the target deceleration rate, the target control pressure is increased by a pressure increment calculated based on the deviation between the actual deceleration rate and the target deceleration rate, so that optimum brake force can be obtained from the accurately calculated pressure increment.

The invention described above is not limited to the above-described embodiment and is carried out in various modes.

In the present embodiment, the number of parameters indicating the motion state of the vehicle is three, however, any number of parameters can be used, and for example, it can be one. As “parameters indicating the motion state of the vehicle (parameters that influence the allowable differential pressure),” for example, a wheel speed, a yaw rate, and a vehicle body acceleration rate, and so on can be used.

In the present embodiment, the pressure increment in the target control pressure is calculated based on the deviation, however, the invention is not limited to this, and for example, it is also possible that the pressure increment is simply fixed to a predetermined value regardless of the deviation.

In the present embodiment, the pressure increment is added to the target control pressure, however, the invention is not limited to this, and it is also possible that the pressure increment is added to the allowable differential pressure selected by the allowable differential pressure setting device 52A (allowable differential pressure selection device A2).

In the present embodiment, information on the depressing amount on the brake pedal is the brake pressure, however, the invention is not limited to this, and the information can be, for example, a stroke (depressing amount itself) of the brake pedal to be detected by a pedal moving amount sensor, or a brake pedal position detected by a displacement sensor.

In the present embodiment, an actual brake pressure is detected by the brake pressure sensor, however, the invention is not limited to this, and the brake pressure can be estimated from other parameters. The lateral acceleration rate is not limited to be detected by the sensor, and it can be estimated from other parameters.

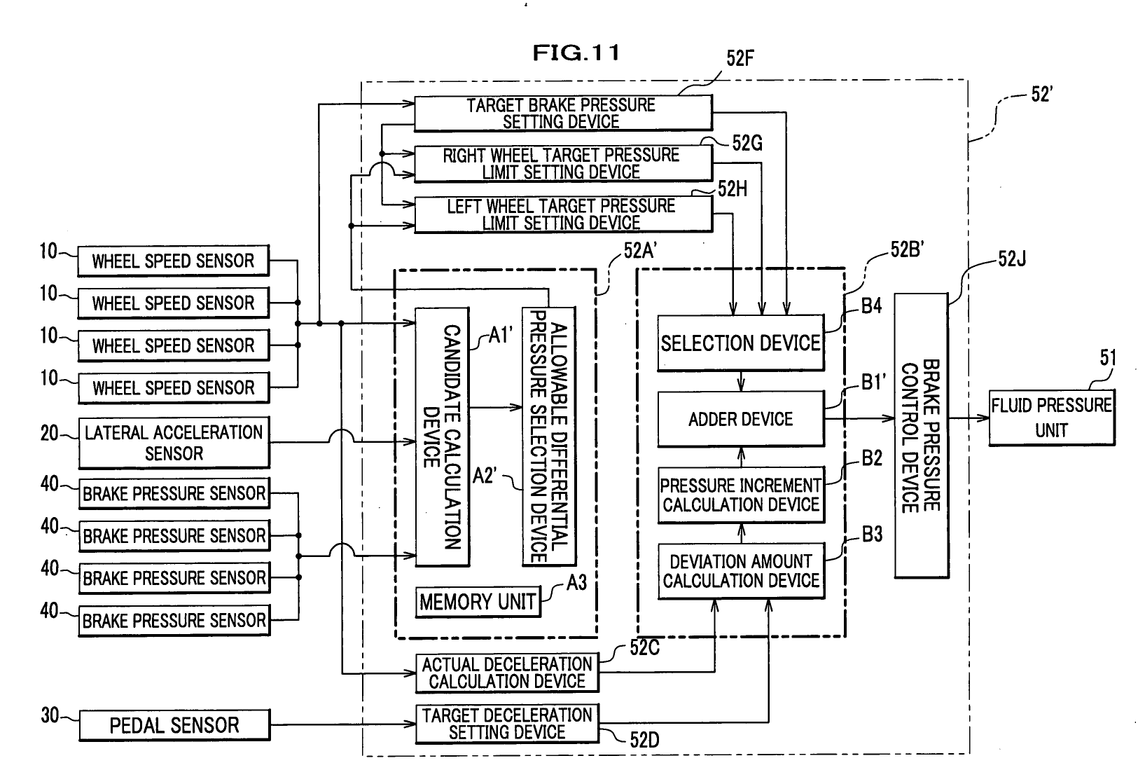

In the present embodiment, only for the wheel on the higher-friction side, a target control pressure is calculated based on an allowable differential pressure and only the higher-friction-side brake pressure is controlled based on the target control pressure. However, the invention is not limited to this, and it is also possible that a target control pressure is calculated for each of the left wheel and the right wheel from the allowable differential pressure, and the left and right wheel brake pressures are separately controlled based on the respective target control pressures. Specifically, the controller can be configured as shown in FIG. 11. The configuration of FIG. 11 will be described below. Since this configuration is a partially modified version of the above-described embodiment (see FIG. 3), description on the same components as in the embodiment described above will be omitted.

As shown in FIG. 11, the controller 52′ includes: an actual deceleration calculation device 52C and a target deceleration setting device 52D each having a similar configuration to the corresponding component in the above-described embodiment; an allowable differential pressure setting device 52A′ and a target control pressure setting device 52B′ having configuration and functions partially different from those in the above-described embodiment; and a target brake pressure setting device 52F, a right wheel target pressure limit setting device 52G, a left wheel target pressure limit setting device 52H, and a brake pressure control device 52J which are not provided in the above-described embodiment.

The allowable differential pressure setting device 52A′ has a candidate calculation device A1′ and an allowable differential pressure selection device A2′ which have functions partially different from those in the above-described embodiment. Unlike the above-described embodiment, the allowable differential pressure selection device A2′ outputs a selected allowable differential pressure not to the adder device B1′ but to a right wheel target pressure limit setting device 52G and a left wheel target pressure limit setting device 52H.

The target brake pressure setting device 52F has a function to set individual target brake pressures of the left and right wheels T,T, and specifically, sets a target brake pressure for each wheel T based on, for example, a slip ratio of each wheel T. It should be noted that the “target brake pressure setting device for setting individual target brake pressures” is not limited to a device configured to set the target brake pressures based on slip ratios of the respective wheels, and may be a device configured to set the target brake pressures based on wheel speeds, for example. Then, this target brake pressure setting device 52F outputs a target brake pressure calculated for the left wheel T to the right wheel target pressure limit setting device 52G, and outputs a target brake pressure calculated for the right wheel T to the left wheel target pressure limit setting device 52H.

The right wheel target pressure limit setting device 52G has a function to set a value obtained by summing up the allowable differential pressure transmitted from the allowable differential pressure selection device A2′ and a target brake pressure for the left wheel T transmitted from the target brake pressure setting device 52E as a target pressure limit of the right wheel T. Then, this right wheel target pressure limit setting device 52G outputs the set target pressure limit of the right wheel T to the target control pressure setting device 52B′.

The left wheel target pressure limit setting device 52H has a function to set a value obtained by summing up the allowable differential pressure transmitted from the allowable differential pressure selection device A2′ and the target brake pressure for the right wheel T transmitted from the target brake pressure setting device 52F as a target pressure limit of the left wheel T. Then, this left wheel target pressure limit setting device 52H outputs the set target pressure limit of the left wheel T to the target control pressure setting device 52B′.

The target control pressure setting device 52B′ has a pressure increment calculation device B2 and a deviation calculation device B having the same functions as in the above-described embodiment, and in addition, has a selection device B4 that is not provided in the above-described embodiment and an adder device B1′ having a function slightly different from that of the above-described embodiment. The selection device B4 has a function to compare the target brake pressure for the right wheel T transmitted from the target brake pressure setting device 52F and the target pressure limit of the right wheel T transmitted from the right wheel target pressure limit setting device 52G, and set the lower value of these as a target control pressure for the right wheel T when the compared values are different, and set either one of these as a target control pressure for the right wheel T when these have no difference (when these are the same values). In addition, in the same manner as described above, the selection device B4 has a function to compare the target brake pressure for the left wheel T transmitted from the target brake pressure setting device 52F and the target pressure limit of the left wheel T transmitted from the left wheel target pressure limit setting device 52H, and set the lower value of these as a target control pressure for the left wheel T when these values are different, and set either one of these values as a target control pressure for the left wheel T when the values have no difference. This selection device B4 outputs these set target control pressures for the left and right wheels T,T to the adder device B1′.

By setting the target control pressures for the respective left and right wheels T,T as described above, the target control pressures satisfy the following relationship. In the description given below, for the sake of convenience, the left wheel T is referred to as “left wheel TL” and the right wheel T is referred to as “right wheel TR.”

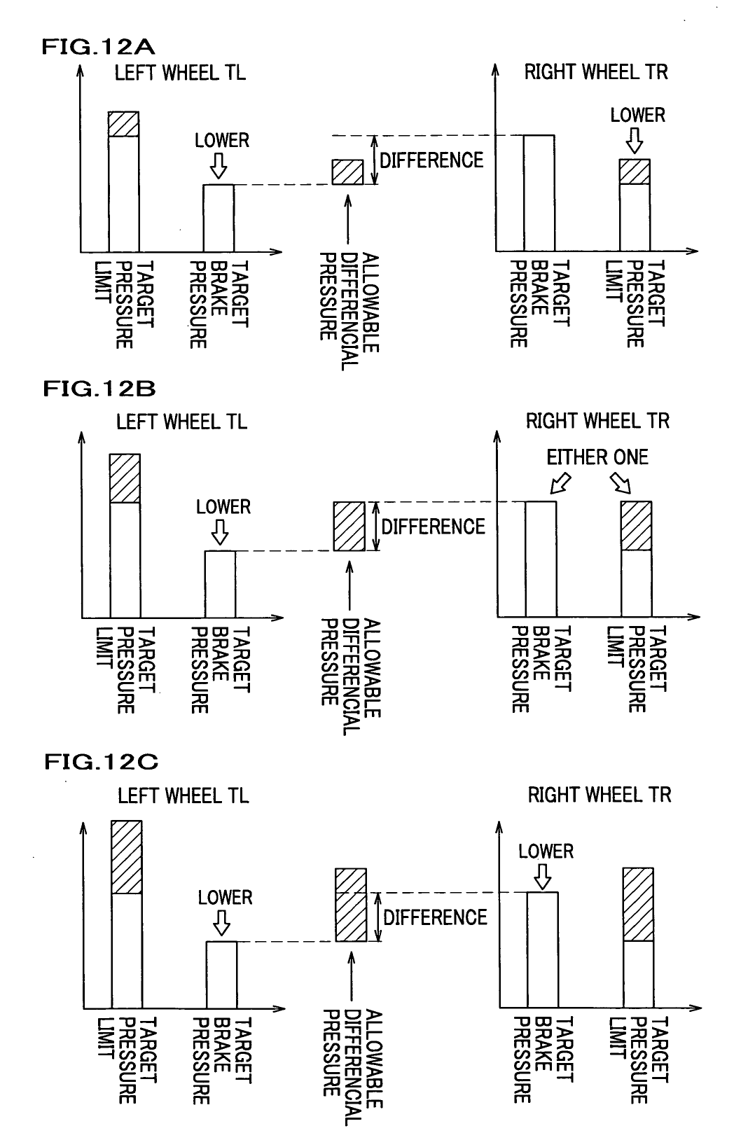

First, as shown in FIG. 12A, when the allowable differential pressure is lower than a difference in the target brake pressure between the left wheel TL and the right wheel TR, a target brake pressure lower than the target pressure limit is set as a target control pressure in either one (left wheel TL in the drawing) of the left wheel TL and the right wheel TR. In the other wheel (right wheel TR in the drawing), a target pressure limit (target brake pressure for left wheel TL+allowable differential pressure) lower than the target brake pressure is set as a target control pressure. In this case, the differential pressure between the left wheel TL and the right wheel TR can be reliably kept at the allowable differential pressure, and the difference between the left and right brake pressures can be reliably restrained from becoming excessively large.

In addition, as shown in FIG. 12B, when the difference in the target brake pressure between the left wheel TL and the right wheel TR and the allowable differential pressure are the same, the target brake pressure is set as a target control pressure in either one (left wheel TL in the drawing) of the left wheel TL and the right wheel TR. In the other wheel (right wheel TR in the drawing), either the target brake pressure or the target pressure limit (these are both equivalent to a value obtained by adding the allowable differential pressure to the target brake pressure of the left wheel TR) is set as a target control pressure. Therefore, in this case, the differential pressure between the left wheel TL and the right wheel TR can be reliably kept at the allowable differential pressure, and the difference between the left and right brake pressures can be reliably restrained from becoming excessively large.

Furthermore, as shown in FIG. 12C, when the allowable differential pressure is higher than a difference in the target brake pressure between the left wheel TL and the right wheel TR, a target brake pressure is set as a target control pressure in each of the left wheel TL and the right wheel TR. Therefore, in this case, the differential pressure between the left wheel TL and the right wheel TR becomes lower than the allowable differential pressure, so that the difference between the left and right brake pressures can be reliably restrained from becoming excessively large.

Referring to FIG. 11 again, the adder device B1′ has a function to output the target control pressures of the respective wheels T outputted from the selection device B4 to the brake pressure control device 52J without change, when no signal is outputted from the pressure increment calculation device B2. The adder device B1′ also has a function, when a signal is outputted from the pressure increment calculation device B2, to add the signal (pressure increment) to the target control pressures of the respective wheels T to increase the target control pressures, and output these values as new target control pressures to the brake pressure control device 52J.

The brake pressure control device 52J has a function to control individual brake pressures by properly controlling the fluid pressure unit 51 so that the brake pressures are adjusted to the respective target control pressures, based on the target control pressures of the respective wheels T outputted from the adder device B1′ and the brake pressures outputted from the brake pressure sensors 40.

Next, operations of the controller 52′ according to the embodiment of FIG. 11 will be described briefly.

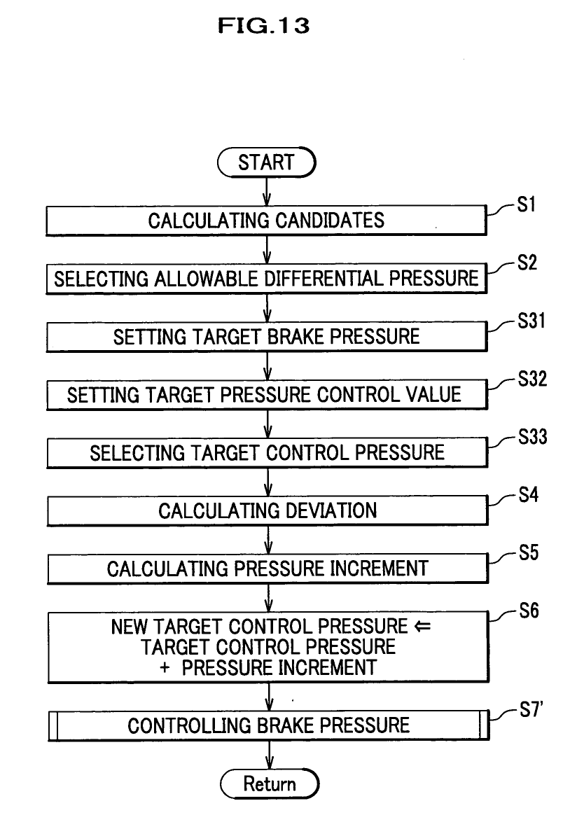

As shown in FIG. 13, the operations of the controller 52′ are basically the same as those of the above-described embodiment (FIG. 5), but are different in that Step S3 of the above-described embodiment is substituted with new steps S31, S32 and S33, and that control conducted at Step S7 which was solely for the higher-friction-side brake pressure is performed on individual brake pressures of the respective wheels T (Step S7′). Therefore, in the description given below, only Steps S31 through S33, which are especially different from the above-described embodiment, will be explained.

At Step S31, target brake pressures of the respective left and right wheels T,T are set by the target brake pressure setting device 52F. At Step S32, respective target pressure limits of the left and right wheels T,T are set by the right wheel target pressure limit setting device 52G and the left wheel target pressure limit setting device 52H. At Step S33, for each of the left wheel TL and the right wheel TR, the lower one of the target brake pressure and the target pressure control value is set as a target control pressure, by the selection device B4 of the target control pressure setting device 52B′.

According to the embodiment shown in FIG. 11 described above, the difference in the target control pressure between the left and right wheels T,T reliably becomes equal to or less than the allowable differential pressure, so that the difference between the left and right brake pressures can be reliably restrained from becoming excessively large.

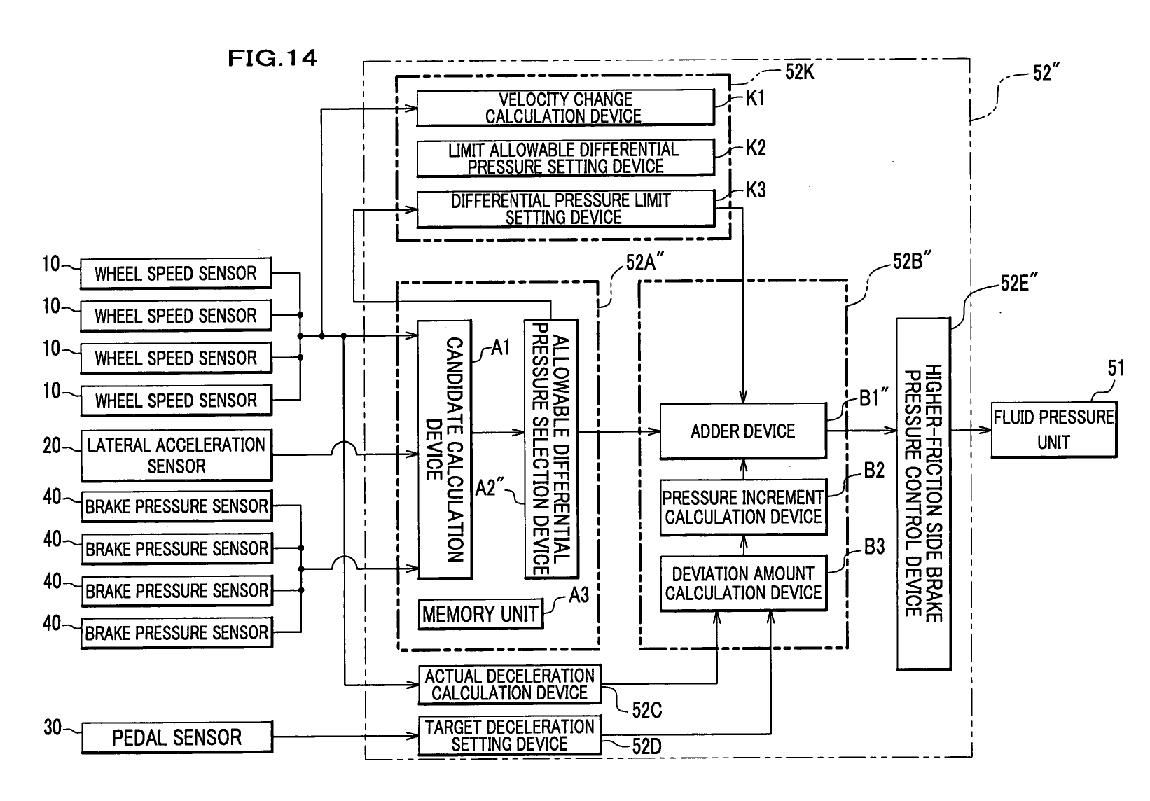

In addition, this embodiment can be configured in such a manner that, as will be described below, a limit allowable differential pressure whose initial value is set to a smaller value than the allowable differential pressure set by the allowable differential pressure setting device 52A is set concurrently when the brake pressure control is started. Specifically, the controller can be configured as shown in FIG. 14. The configuration of FIG. 14 will be described below. Since this configuration is a partially modified version of the above-described embodiment (see FIG. 3), description on the same components as in the above-described embodiment will be omitted.

As shown in FIG. 14, the controller 52″ includes: an actual deceleration calculation device 52C, a target deceleration setting device 52D, and a higher-friction-side brake pressure control device 52E″ having a similar configuration to the corresponding component in the above-described embodiment; an allowable differential pressure setting device 52A″ with an additional output destination as compared with the case of the above-described embodiment; a target control pressure setting device 52B″ with an additional input source; and an allowable differential pressure limiting device 52K that is not provided in the above-described embodiment.

The allowable differential pressure setting device 52A″ outputs a lower-friction-side brake pressure selected by the candidate calculation device A1 from the allowable differential pressure selection device A2″ to the target control pressure setting device 52B″ (in detail, the adder device B1″). On the other hand, a brake pressure on the opposite side to a side with the lower-friction-side brake pressure (i.e. higher-friction-side brake pressure) is output from the allowable differential pressure setting device 52A″ through the adder device B1″ to the higher-friction-side brake pressure control device 52E″.

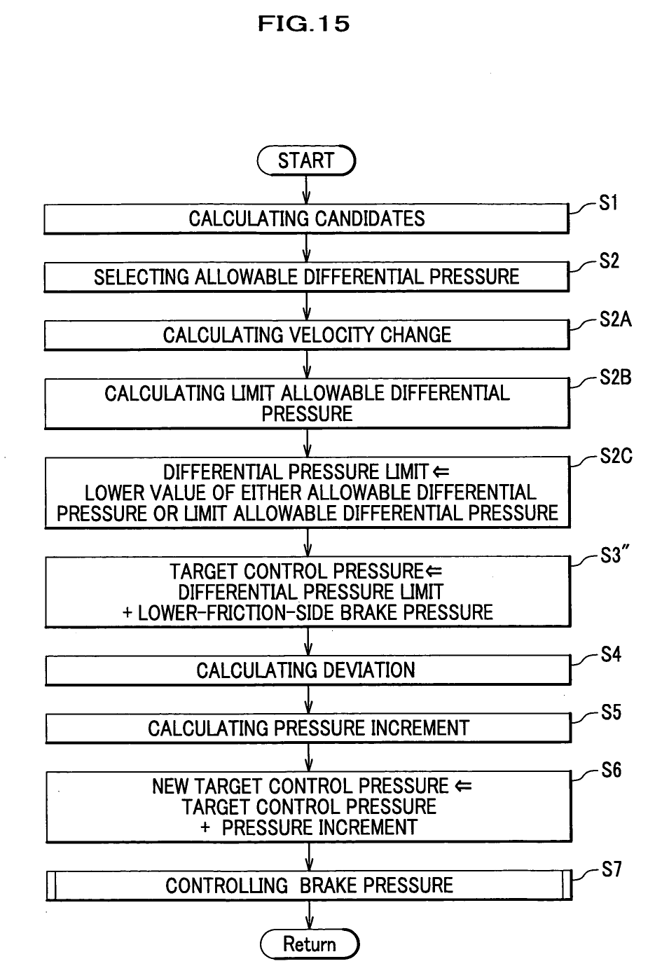

The allowable differential pressure selection device A2″ also has a function (FIG. 15, Step S2) to select and set a candidate with the highest allowable differential pressure among the differential pressure candidates transmitted from the candidate calculation device A1 as an allowable differential pressure, and outputs the selected allowable differential pressure to the allowable differential pressure limiting device 52K (specifically, a differential pressure limit setting device K3).

The allowable differential pressure limiting device 52K has a function to set a limit allowable differential pressure whose initial value is set to a smaller value than the allowable differential pressure set by the allowable differential pressure setting device 52A″. Specifically, for example, when receiving a control start signal from an unillustrated anti-lock braking control device, a limit allowable differential pressure is set, in which the differential pressure between the higher-friction side and the lower-friction side is set to zero. For attaining this, the allowable differential pressure limiting device 52K includes a velocity change calculation device K1, a limit allowable differential pressure setting device K2, and a differential pressure limit setting device K3. The limit allowable differential pressure is not limited to zero as set in the embodiment above, and a value more than zero and smaller than the allowable differential pressure can be set as an initial value thereof.

The velocity change calculation device K1 has a function (FIG. 15, Step S2A) to calculate a velocity change of the wheel speed according to a change in wheel speed on the higher-friction side. Specifically, when receiving a control start signal from an unillustrated anti-lock braking control device, the wheel speed on the higher-friction side is kept and set as a reference speed, and a change (or deviation) in wheel speed on the higher-friction side from this reference speed is calculated as a velocity change. Herein, “velocity change” is a value calculated by subtracting a higher-friction-side wheel speed from the reference speed. Then, the velocity change calculation device K1 outputs the calculated velocity change to the limit allowable differential pressure setting device K2.

The limit allowable differential pressure setting device K2 has a function (FIG. 15, Step S2B) to calculate a limit allowable differential pressure based on the velocity change calculated by the velocity change calculation device K1, specifically, a function to calculate a limit allowable differential pressure by multiplying the velocity change by a predetermined coefficient. For example, at the time of starting the brake pressure control, the reference speed and the higher-friction-side wheel speed are the same and the velocity change is zero, and thus the limit allowable differential pressure is set to zero. After starting the brake pressure control, while controlling of the brake pressure is under way, the velocity change between the reference speed and the higher-friction-side wheel speed gradually increases, and thus the limit allowable differential pressure is set to a larger value, accordingly. In other words, when the velocity change becomes larger, the limit allowable differential pressure gradually increases accordingly and is made to approach the allowable differential pressure. Then, the limit allowable differential pressure setting device K2 outputs the calculated limit allowable differential pressure to the differential pressure limit setting device K3.

The differential pressure limit setting device K3 has a function (FIG. 15, Step S2C) to compare the allowable differential pressure transmitted from the allowable differential pressure selection device A2″ and the limit allowable differential pressure transmitted from the limit allowable differential pressure setting device K2, and sets the lower one of these as a differential pressure limit when these are different from each other, and sets either one of these as a differential pressure limit when these are not different (equal to each other) Specifically, for example, at the time of starting the brake pressure control, the limit allowable differential pressure is set to zero and lower than the allowable differential pressure as described above, so that the limit allowable differential pressure is set as the differential pressure limit. After starting the brake pressure control, when the limit allowable differential pressure increases as controlling of the brake pressure is under way and becomes higher than the allowable differential pressure, the allowable differential pressure that is lower is set as the differential pressure limit. In other words, at the time of starting the brake pressure control, the limit allowable differential pressure is regarded as an allowable differential pressure and set as a differential pressure limit, and when the limit allowable differential pressure becomes higher than the allowable differential pressure as controlling of the brake pressure is under way, the setting is set back to the allowable differential pressure from the limit allowable differential pressure and the allowable differential pressure is set as a differential pressure limit. Then, the differential pressure limit setting device K3 outputs the set differential pressure limit to the adder device B1″ of the target control pressure setting device 52B″.

The adder device B1″ has a function (FIG. 15, Step S3″) to add the lower-friction-side brake pressure outputted from the allowable differential pressure setting device 52A″ to the differential pressure limit outputted from the allowable differential pressure limiting device 52K and sets a resultant value as a target control pressure when no signal is outputted from the pressure increment calculation device B2. This adder device B1″ also has a function, when a signal is outputted from the pressure increment calculation device B2, to add the signal (pressure increment) to the target control pressure to increase the target control pressure and set a resultant value as a new target control pressure (FIG. 15, Step S6). This adder device B1″ outputs the target control pressure or the new target control pressure set as described above to the higher-friction-side brake pressure control device 52E″.

Next, operations of the controller 52″ according to an embodiment of FIG. 14 will be described briefly.

As shown in FIG. 15, the operations of the controller 52″ are basically the same as those of the above-described embodiment (FIG. 5), but are different in that new steps S2A, S2B, and S2C are added and the target control pressure of the higher-friction-side brake pressure is set by a different method from that in the above-described embodiment. Therefore, in the description given below, only the Steps S2A through S3″ as operations different in comparison with the above-described embodiment will be particularly described.

At Step S2A, a velocity change of the wheel speed according to a change in wheel speed on the higher-friction side is calculated by the velocity change calculation device K1 of the allowable differential pressure limiting device 52K. At Step S2B, a limit allowable differential pressure is calculated by the limit allowable differential pressure setting device K2 based on the velocity change calculated by the velocity change calculation device K1. Then, at step SC, the lower one of an allowable differential pressure transmitted from the allowable differential pressure selection device A2″ and the limit allowable differential pressure transmitted from the limit allowable differential pressure setting device K2 is set as a differential pressure limit. Thereafter, at Step S3″, the differential pressure limit set at Step S2C and the lower-friction-side brake pressure are summed up by the adder device B1″, and a resultant value is set as a target control pressure.

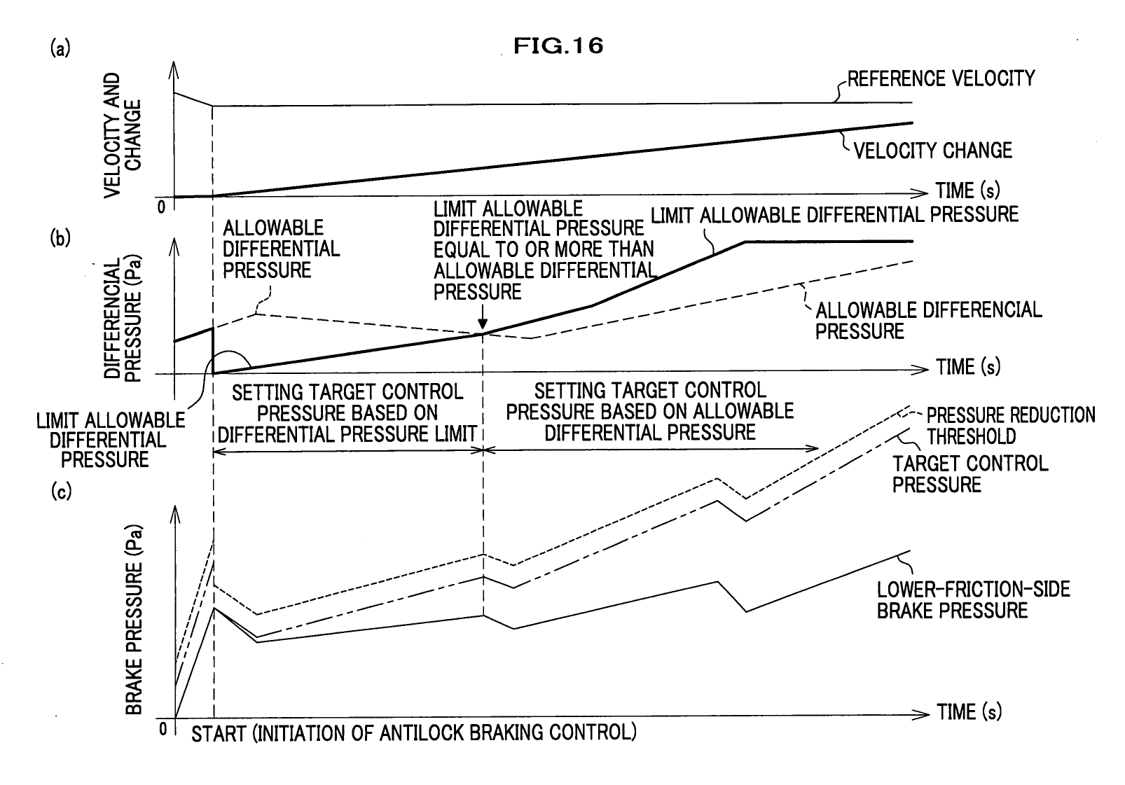

Next, an example of the above-described differential pressure control performed for a predetermined period of time will be described. Referring to FIG. 16, (a) shows an example of time changes in reference speed and velocity change, (b) shows an example of a time change in allowable differential pressure to be updated as required, and (c) shows an example of time changes in lower-friction-side brake pressure and target control pressure.

As shown in (a) of FIG. 16, when the brake pedal BP is depressed and the anti-lock braking control is started, a wheel speed at the time of start of the anti-lock braking control is kept and set until the depression of the brake pedal BP is cancelled. A velocity change of the wheel speed relative to the reference speed gradually increases while controlling of the brake pressure is under way as shown in the graph.

As shown in (b) of FIG. 16, allowable differential pressure setting (the above-described calculation and selection of candidates) is always performed after depression of the brake pedal BP till cancellation of the depression, and by updating the set value as required based on the parameters and maps, the allowable differential pressure (set value) changes with time as shown in the graph. On the other hand, the limit allowable differential pressure is set to zero when the anti-lock braking control is started, and then changes with time based on the velocity change of the wheel speed as shown in the graph. It should be noted that the limit allowable differential pressure gradually approaches the allowable differential pressure as the time elapsed, and becomes higher than the allowable differential pressure, as shown in the graph.

Then, in the case where the allowable differential pressure and the limit allowable differential pressure change with time in this manner, when the lower-friction-side brake pressure changes with time as shown in (c) of FIG. 16, a target control pressure of the higher-friction-side brake pressure obtained by adding the differential pressure limit that is the lower value between the allowable differential pressure and the limit allowable differential pressure to the lower-friction-side brake pressure changes with time as shown by the alternate long and short double dashed line of the graph. A pressure reduction threshold obtained by adding a predetermined value to the target control pressure changes with time along with the target control pressure (as if offsetting the target control pressure).

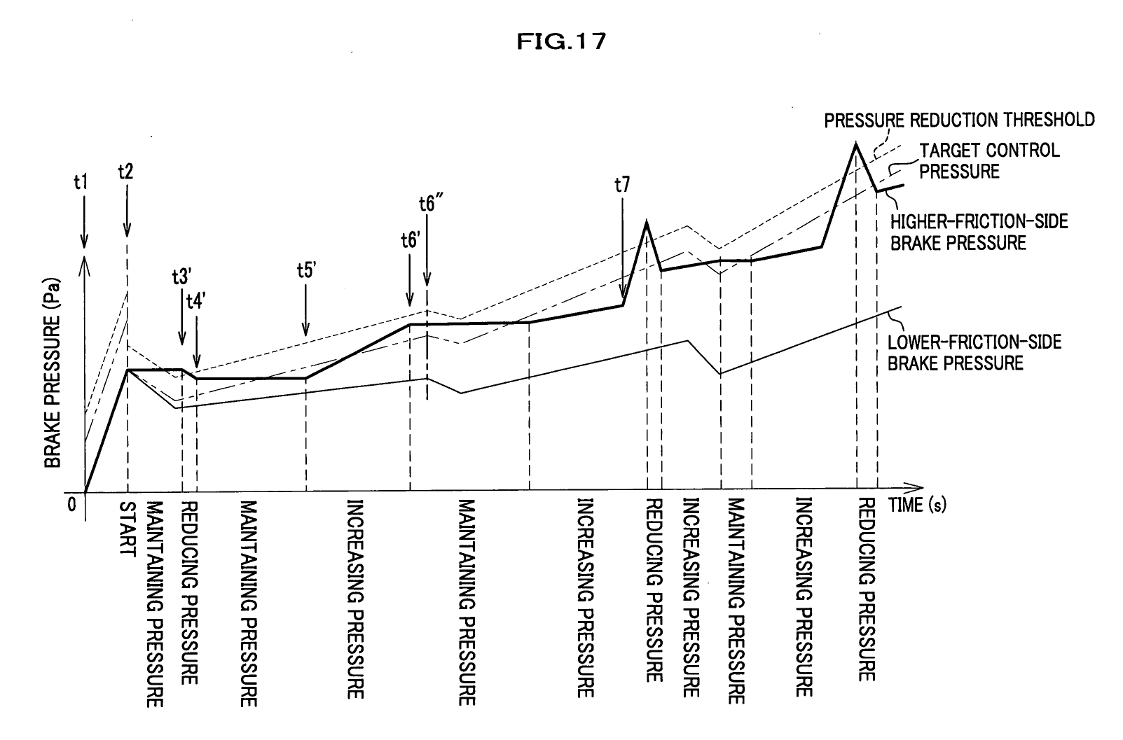

Next, a method for controlling the higher-friction-side brake pressure will be described with reference to FIG. 17. Among the drawings to be referred to, FIG. 17 is a graph showing a method for controlling the higher-friction-side brake pressure.

As shown in FIG. 17, when a driver depresses the brake pedal BP (at time t1), calculation of the target control pressure is started and the left and right brake pressures increase together (in a time period of t1-t2). Then, when the vehicle CR enters a split road surface and a wheel T on one side slips, anti-lock braking control is started, and the brake pressure (lower-friction-side brake pressure) to be applied to the slipping wheel T is reduced (at time t2). At the same time, the brake pressure to be applied to the opposite side wheel T that has not slipped (higher-friction-side brake pressure) is reduced upon setting its differential pressure limit relative to the lower-friction-side brake pressure to zero. This control follows a basic flow in FIG. 15, from START through Steps S1-S7 to RETURN in this order. A limit allowable differential pressure is set to the differential pressure limit at Step S2C, a target control pressure is set based on this differential pressure limit at Step S3″, and various controls according to the conditions are performed at Step S7. The controls at Step S7 (hereinafter, simply referred to as “brake pressure control”) proceeds from START through Step S71 (No) to END in this order as shown in FIG. 6 in a time period of t1-t2. The brake pressure control in a time period of t2-t3′ proceeds from START through Step S71 (Yes), Step S72 (Yes), Step S73 (No) and Step S75 to END in this order.

Returning to FIG. 17, when the higher-friction-side brake pressure becomes higher than the pressure reduction threshold at time t3′, control for reducing the higher-friction-side brake pressure is performed, and when the higher-friction-side brake pressure becomes lower than a pressure reduction threshold (time t4′), control for maintaining the higher-friction-side brake pressure is performed. Furthermore, when the higher-friction-side brake pressure becomes lower than the target control pressure (time t5′), control for increasing the higher-friction-side brake pressure is performed.

The pressure reducing control in a time period of t3′-t4′ proceeds from START through Step S71 (Yes), Step S72 (Yes), Step S73 (Yes) and Step S74 to END in this order as shown in FIG. 6. The pressure maintaining control in a time period of t4′-t5′ proceeds from START through Step S71 (Yes), Step S72 (Yes), Step S73 (No) and Step S75 to END in this order. Furthermore, the pressure increasing control in a time period of t5′-t6′ proceeds from START through Step S71 (Yes), Step S72 (No) and Step S76 to END in this order.

After time t6′, the limit allowable differential pressure that had been set as a differential pressure limit becomes higher than the allowable differential pressure from time t6″ (see (b) of FIG. 16). Therefore, the differential pressure is set back from the limit allowable differential pressure to the allowable differential pressure, and after this, the allowable differential pressure is set as a differential pressure limit, based on which a target control pressure is set. With this configuration, in comparison with the case where the limit allowable differential pressure is continuously set as the differential pressure limit, the difference between the left and right brake pressures can be reliably restrained from becoming excessively large.

As described above, according to the embodiment shown in FIG. 14, when the anti-lock braking control is started, the differential pressure limit is set to a limit allowable differential pressure whose initial value is set to a value smaller than the allowable differential pressure (or to zero) by the allowable differential pressure limiting device 52K. This limit allowable differential pressure is regarded as an allowable differential pressure and a target control pressure is set by the target control pressure setting device 52B″. Based on this limit allowable differential pressure, the brake pressures are controlled, so that the difference between the higher-friction-side brake pressure and the lower-friction-side brake pressure is kept at the limit allowable differential pressure that is further smaller than the vicinity of the allowable differential pressure corresponding to the motion state of the vehicle, and the difference between the left and right brake pressures can be more reliably restrained from becoming excessively large. In addition, a phenomenon such as vibration of the vehicle CR at initial braking is hardly caused, and straight running stability on a split road surface is improved.

Furthermore, the allowable differential pressure limiting device 52K sets the initial value of the limit allowable differential pressure to zero, and therefore when the anti-lock braking control is started, a braking state in which the difference in brake pressure is zero between the higher-friction side and the lower-friction side is set, that is, the higher-friction-side brake pressure and the lower-friction-side brake pressure are set to be the same. As a result, the difference between the left and right brake pressures can be reliably restrained from becoming excessively large. Also, it becomes harder to cause a phenomenon such as vibration of the vehicle CR at initial stage of braking, and straight running stability on a split road surface is further improved.

In addition, the allowable differential pressure limiting device 52K sets the limit allowable differential pressure so as to make the limit allowable differential pressure approach the allowable differential pressure set by the allowable differential pressure setting device 52A″ while controlling of the brake pressure is under way. Therefore, the difference between the higher-friction-side brake pressure and the lower-friction-side brake pressure is suitably set while controlling of the brake pressure is underway, and the difference between the left and right brake pressures can be more reliably restrained from becoming excessively large.

In addition, the vehicle speed at starting of the brake pressure control is set as a reference speed, and a velocity change of the wheel speed relative to this reference speed is calculated. Therefore, once the brake pressure control is started, a proper limit allowable differential pressure based on the velocity change of the wheel speed is set as a differential pressure between the higher-friction side and the lower-friction side, and the difference between the left and right brake pressures can be more reliably restrained from becoming excessively large.

Then, when the limit allowable differential pressure is lower than the allowable differential pressure, the limit allowable differential pressure is set as a differential pressure limit. Therefore, the differential pressure between the left and right wheels can be reliably kept at the limit allowable differential pressure lower than the allowable differential pressure, and the difference between the left and right brake pressures can be reliably restrained from becoming excessively large. In addition, when the limit allowable differential pressure becomes higher than the allowable differential pressure, the allowable differential pressure is set as a differential pressure limit. Therefore, the differential pressure between the left and right wheels can be reliably kept at the allowable differential pressure, and the difference between the left and right brake pressures can be reliably restrained from becoming excessively large. When the allowable differential pressure and the limit allowable differential pressure are equal to each other, either the allowable differential pressure or the limit allowable differential pressure is set as a differential pressure limit. Therefore, in this case, the differential pressure between the left and right wheels can also be reliably kept at the allowable differential pressure or the limit allowable differential pressure, and thus the difference between the left and right brake pressures can be reliably restrained from becoming excessively large.

Furthermore, by the velocity change calculation device K1, the velocity change of the wheel speed is calculated according to a change in wheel speed on the higher-friction side with smaller wheel slipping. Therefore, the calculation of the velocity change is properly performed, and as a result, a limit allowable differential pressure corresponding to the velocity change is properly set. Thus, the difference between the left and right brake pressures can be more reliably restrained from becoming excessively large.

What is claimed is:

1. A brake pressure controller for a vehicle comprising:
an allowable differential pressure setting device for setting an allowable differential pressure between a left wheel and a right wheel on an identical axle based on parameters indicating a motion state of a vehicle;
a target control pressure setting device for setting a value obtained by summing up the allowable differential pressure set by the allowable differential pressure setting device and a lower-friction-side brake pressure to be applied to a lower-friction-side wheel of the left and right wheels, as a target control pressure of a higher-friction-side brake pressure to be applied to a higher-friction-side wheel; and
a higher-friction-side brake pressure control device for adjusting the higher-friction-side brake pressure to the target control pressure.

2. A brake pressure controller for a vehicle comprising:
an allowable differential pressure setting device for setting an allowable differential pressure between a left wheel and a right wheel on an identical axle based on parameters indicating a motion state of a vehicle;
a target brake pressure setting device for setting individual target brake pressures of the left and right wheels;
a right wheel target pressure limit setting device for setting a value obtained by summing up the allowable differential pressure and the target brake pressure of the left wheel as a target pressure limit of the right wheel;
a left wheel target pressure limit setting device for setting a value obtained by summing up the allowable differential pressure and the target brake pressure of the right wheel as a target pressure limit of the left wheel;
a target control pressure setting device for setting the lower one between the target brake pressure and the target pressure limit for the left wheel as a target control pressure of the left wheel and setting the lower one between the target brake pressure and the target pressure limit for the right wheel as a target control pressure of the right wheel; and
a brake pressure control device for adjusting individual brake pressures of the left and right wheels to the respective target control pressures.

3. The brake pressure controller according to claim 1, wherein
the parameters are a speed of a vehicle body, a lateral acceleration rate to be applied to the vehicle body, and a lower-friction-side brake pressure of the brake pressures to be applied to the left and right wheels, and
the allowable differential pressure setting device comprises:
a candidate calculation device for calculating a first candidate of the allowable differential pressure based on the vehicle body speed, calculating a second candidate of the allowable differential pressure based on the lateral acceleration rate, and calculating a third candidate of the allowable differential pressure based on the lower-friction-side brake pressure; and
an allowable differential pressure selection device for selecting and setting the highest one among the first, second, and third candidates calculated by the candidate calculation device, as the allowable differential pressure.

4. The brake pressure controller according to claim 2, wherein
the parameters are a speed of a vehicle body, a lateral acceleration rate to be applied to the vehicle body, and a lower-friction-side brake pressure of the brake pressures to be applied to the left and right wheels, and
the allowable differential pressure setting device comprises:
a candidate calculation device for calculating a first candidate of the allowable differential pressure based on the vehicle body speed, calculating a second candidate of the allowable differential pressure based on the lateral acceleration rate, and calculating a third candidate of the allowable differential pressure based on the lower-friction-side brake pressure; and
an allowable differential pressure selection device for selecting and setting the highest one among the first, second, and third candidates calculated by the candidate calculation device, as the allowable differential pressure.

5. The brake pressure controller according to claim 3, wherein
the allowable differential pressure setting device comprises a memory unit storing a plurality of maps or functions indicating relationships between each of the vehicle body speed, the lateral acceleration rate and the lower-friction-side brake pressure, and the allowable differential pressure, and
the candidate calculation device calculates the candidates from the respective maps or functions.

6. The brake pressure controller according to claim 4, wherein
the allowable differential pressure setting device comprises a memory unit storing a plurality of maps or functions indicating relationships between each of the vehicle body speed, the lateral acceleration rate and the lower-friction-side brake pressure, and the allowable differential pressure, and
the candidate calculation device calculates the candidates from the respective maps or functions.

7. The brake pressure controller according to claim 1, further comprising:
a target deceleration setting device for setting a target deceleration rate of a higher-friction-side wheel based on information on an operating amount of a brake operating element; and
an actual deceleration calculation device for calculating an actual deceleration rate of the higher-friction-side wheel based on an actual speed of the higher-friction-side wheel, wherein
the allowable differential pressure setting device or the target control pressure setting device compares the target deceleration rate set by the target deceleration setting device and the actual deceleration rate calculated by the actual deceleration calculation device, and increases the allowable differential pressure or the target control pressure when the actual deceleration rate is lower than the target deceleration rate by a predetermined amount or more.

8. The brake pressure controller according to claim 2, further comprising:
a target deceleration setting device for setting a target deceleration rate of a higher-friction-side wheel based on information on an operating amount of a brake operating element; and
an actual deceleration calculation device for calculating an actual deceleration rate of the higher-friction-side wheel based on an actual speed of the higher-friction-side wheel, wherein
the allowable differential pressure setting device or the target control pressure setting device compares the target deceleration rate set by the target deceleration setting device and the actual deceleration rate calculated by the actual deceleration calculation device, and increases the allowable differential pressure or the target control pressure when the actual deceleration rate is lower than the target deceleration rate by a predetermined amount or more.

9. The brake pressure controller according to claim 7, wherein
the allowable differential pressure setting device or the target control pressure setting device comprises:
a deviation calculation device for calculating a deviation between the actual deceleration rate and the target deceleration rate; and
a pressure increment calculation device for calculating a pressure increment in the allowable differential pressure or the target control pressure based on the deviation calculated by the deviation calculation device, and
increases the allowable differential pressure or the target control pressure by adding the pressure increment calculated by the pressure increment calculation device to the allowable differential pressure or the target control pressure.

10. The brake pressure controller according to claim 8, wherein
the allowable differential pressure setting device or the target control pressure setting device comprises:
a deviation calculation device for calculating a deviation between the actual deceleration rate and the target deceleration rate; and
a pressure increment calculation device for calculating a pressure increment in the allowable differential pressure or the target control pressure based on the deviation calculated by the deviation calculation device, and
increases the allowable differential pressure or the target control pressure by adding the pressure increment calculated by the pressure increment calculation device to the allowable differential pressure or the target control pressure.

11. The brake pressure controller according to claim 1, further comprising:
an allowable differential pressure limiting device for setting a limit allowable differential pressure having an initial value being set to a smaller value than the allowable differential pressure set by the allowable differential pressure setting device when controlling the brake pressure gets started, wherein
the target control pressure setting device regards the limit allowable differential pressure as an allowable differential pressure and sets a target control pressure.

12. The brake pressure controller according to claim 2, further comprising:
an allowable differential pressure limiting device for setting a limit allowable differential pressure having an initial value being set to a smaller value than the allowable differential pressure set by the allowable differential pressure setting device when controlling the brake pressure gets started, wherein
the target control pressure setting device regards the limit allowable differential pressure as an allowable differential pressure and sets a target control pressure.

13. The brake pressure controller according to claim 11, wherein
the allowable differential pressure limiting device sets the initial value to zero, and sets the limit allowable differential pressure so as to make the limit allowable differential pressure approach the allowable differential pressure set by the allowable differential pressure setting device while controlling the brake pressure is under way.

14. The brake pressure controller according to claim 12, wherein
the allowable differential pressure limiting device sets the initial value to zero, and sets the limit allowable differential pressure so as to make the limit allowable differential pressure approach the allowable differential pressure set by the allowable differential pressure setting device while controlling the brake pressure is under way.

15. The brake pressure controller according to claim 11, wherein
the allowable differential pressure limiting device sets the limit allowable differential pressure back to the allowable differential pressure set by the allowable differential pressure setting device when the limit allowable differential pressure becomes higher than the allowable differential pressure set by the allowable differential pressure setting device, and
the target control pressure setting device sets a target control pressure based on the allowable differential pressure.

16. The brake pressure controller according to claim 12, wherein
the allowable differential pressure limiting device sets the limit allowable differential pressure back to the allowable differential pressure set by the allowable differential pressure setting device when the limit allowable differential pressure becomes higher than the allowable differential pressure set by the allowable differential pressure setting device, and
the target control pressure setting device sets a target control pressure based on the allowable differential pressure.

17. The brake pressure controller according to claim 11, wherein
the allowable differential pressure limiting device comprises:
a velocity change calculation device for setting a wheel speed at an initiation of the brake pressure control as a reference speed and calculating a velocity change of a wheel speed relative to the reference speed;
a limit allowable differential pressure setting device for setting the limit allowable differential pressure according to the velocity change calculated by the velocity change calculation device; and
a differential pressure limit setting device for setting the lower one between the allowable differential pressure set by the allowable differential pressure setting device and the limit allowable differential pressure set by the limit allowable differential pressure setting device, as a differential pressure limit.

18. The brake pressure controller according to claim 12, wherein
the allowable differential pressure limiting device comprises:
a velocity change calculation device for setting a wheel speed at an initiation of the brake pressure control as a reference speed and calculating a velocity change of a wheel speed relative to the reference speed;
a limit allowable differential pressure setting device for setting the limit allowable differential pressure according to the velocity change calculated by the velocity change calculation device; and
a differential pressure limit setting device for setting the lower one between the allowable differential pressure set by the allowable differential pressure setting device and the limit allowable differential pressure set by the limit allowable differential pressure setting device, as a differential pressure limit.

19. The brake pressure controller according to claim 17, wherein the velocity change calculation device calculates a velocity change of a wheel speed according to a change in a wheel speed of the higher-friction side.

20. The brake pressure controller according to claim 18, wherein the velocity change calculation device calculates a velocity change of a wheel speed according to a change in a wheel speed of the higher-friction side.
